(19) United States
(12) Patent Application Publication
(10) Pub. No.: US 2021/0312444 A1
(43) Pub. Date: Oct. 7, 2021

(54) DATA PROCESSING METHOD, NODE, BLOCKCHAIN NETWORK, AND VIRTUAL DATA CARRIER

(71) Applicant: Zhuo Liu, Beijing (CN)

(72) Inventor: Zhuo Liu, Beijing (CN)

(21) Appl. No.: 17/265,105

(22) PCT Filed: Apr. 23, 2019
(86) PCT No.: PCT/CN2019/083809

§ 371 Date: Feb. 1, 2021

(30) Foreign Application Priority Data
Aug. 2, 2018 (CN) 201810873793.6

(51) Int. Cl. G06Q 20/40; G06Q 20/38; G06Q 20/06; H04L 9/32

(52) U.S. Cl. CPC G06Q 20/405; G06Q 20/4016; G06Q 20/3821; G06Q 2220/00; H04L 9/32; H04L 2209/38; H04L 2209/56; G06Q 20/065

(57) ABSTRACT

A data processing method, a node, a blockchain network, and a virtual data carrier are provided. The data processing method includes receiving a block addition message which is with respect to a target virtual data carrier and sent by any one node in a blockchain network, the block addition message including a digital identifier and data change information, the blockchain network including a plurality of virtual data carriers storing data character information, and each virtual data carrier is provided with a unique digital identifier and corresponds to at least one blockchain; acquiring target blockchain information corresponding to the target virtual data carrier, according to the digital identifier corresponding to the target virtual data carrier; and judging, based on data change history information of at least one block in the target blockchain information, whether the data change information is legitimate, and if legitimate, confirming the data change information.

### TECHNICAL FIELD

The application relates to a technical field of blockchain, in particular to a data processing method, a node, a blockchain network, and a virtual data carrier.

### BACKGROUND

Blockchain is a technology that prevents tampering with data, and is implemented by using hash operation or a certain operation with a similar function. A blockchain network including multiple nodes usually allows a block added only to a very end of a blockchain, and a hash value of a previous block added to a new data block, which are jointly hashed to obtain a hash value of the present block, which is further added to obtain a new block. The hash value may verify input data of hash operation, and the input data comprises the hash value of the previous block, so the input data for hash operation of the previous block may be verified, thereby further tracing all the way back to verify a root block of the blockchain, that is, input data of each block on the entire blockchain may be verified, so that in the case where data in the blockchain is illegitimately tampered with, the tampering behavior may be discovered through the traceable verification process.

During data processing of the existing blockchain network, because all operation records in the blockchain network are saved on a same blockchain, respective nodes have to get permission to add blocks through a competition and consensus mechanism, such as proof of work, and after receiving a block addition message broadcast, the respective nodes also have to reach a consensus on the block addition message with other nodes through the competition and consensus mechanism, such as proof of work. In other words, data processing of the existing blockchain network has problems of complex processing and power consumption.

On such basis, how to provide a data processing method applied to the blockchain network that can simplify the processing procedure and reduce power consumption is an urgent problem to be solved.

### SUMMARY

With respect to the problems in the prior art, the present disclosure provides a data processing method, a node, a blockchain network, and a virtual data carrier, which can effectively simplify the data processing of the blockchain network while ensuring the decentralization and security of the blockchain network, and can effectively lower power consumption for the data processing.

In order to solve the above-described technical problems, the present disclosure provides technical solutions as below.

In a first aspect, the present disclosure provides a data processing method, comprising: receiving a block addition message which is with respect to a target virtual data carrier and sent by any one node in a blockchain network, the block addition message comprising a digital identifier corresponding to the target virtual data carrier, data change information, and an owner user identifier, the blockchain network comprising a plurality of virtual data carriers storing data character information, and each virtual data carrier being provided with a unique corresponding digital identifier and corresponding to at least one blockchain; acquiring target blockchain information corresponding to the target virtual data carrier, according to the digital identifier corresponding to the target virtual data carrier; and judging, based on data change history information, which is in the target blockchain information, of at least one block, whether the data change information in the block addition message is legitimate, and if legitimate, confirming the data change information in the block addition message.

Further, the data processing method also comprises: receiving a notification message, which comprises the data change information and the owner user identifier, is with respect to an illegitimate operation and sent by any one node in the blockchain network; and sanctioning an owner user who performs the illegitimate operation, if the illegitimate operation on the data change information is determined to belong to one of preset operations with serious circumstances.

Further, the data processing method also comprises: when or after the data change information in the block addition message is determined to be illegitimate, if an operation on the data change information is determined to belong to one of preset operations with serious circumstances, adding an illegitimate authority declaration block into target blockchain information corresponding to all virtual data carriers of which the owner user is a target user who executes the operation, and broadcasting, so that other nodes in the blockchain network refuse to verify an ownership transfer block added by the target user onto the virtual data carrier onto which the illegitimate authority declaration block is added.

Further, the data processing method also comprises receiving an ownership transfer instruction which is with respect to the target virtual data carrier and sent by a corresponding owner user, the ownership transfer instruction comprising the digital identifier of the target virtual data carrier and a designated user identifier; acquiring, according to the digital identifier of the target virtual data carrier, a current owner user identifier from a block involved in a last completed ownership transfer in a blockchain corresponding to the target virtual data carrier; and judging whether the owner user identifier acquired from the block involved in the last completed ownership transfer is identical to an owner user identifier corresponding to the owner user who sends out the ownership transfer instruction; if identical, adding, based on the designated user identifier, a payment block to the blockchain corresponding to the target virtual data carrier, and broadcasting a block addition message corresponding to the payment block to the blockchain network; the data change information in the block addition message comprises change time, change contents, and the designated user identifier.

Further, after broadcasting the block addition message corresponding to the payment block to the blockchain network, the method further comprises: if a transfer confirmation message sent by a designated user of a transfer-out block corresponding to the block addition message is not received within a preset time period, adding a transfer cancellation block corresponding to the transfer-out block to the blockchain corresponding to the target virtual data carrier, and broadcasting a block addition message corresponding to the transfer cancellation block to the blockchain network; an owner user identifier in the transfer cancellation block is an original owner user identifier in the corresponding transfer-out block.

Further, after broadcasting the block addition message corresponding to the payment block to the blockchain network, the method further comprises: if a transfer rejection message broadcast in the blockchain network by the designated user of the transfer-out block corresponding to the block addition message is received within a preset time period, determining that the current owner user of the corresponding target virtual data carrier is still the owner user who sends out the ownership transfer instruction with respect to the target virtual data carrier.

Further, the data processing method further comprises: receiving a block addition message which corresponds to a transfer-out block with respect to the target virtual data carrier and is broadcast by any one node in the blockchain network; and if the block addition message corresponding to the transfer-out block comprises an execution condition, after the execution condition is met, adding a reception block to a blockchain corresponding to the target virtual data carrier and broadcasting the reception block to the blockchain network, the reception block comprising data that can prove that the execution condition has been met.

Further, the data processing method further comprises: receiving a block addition message which corresponds to a transfer-out block with respect to the target virtual data carrier and is broadcast by any one node in the blockchain network; and if a block addition message, which conflicts with the transfer-out block and sent out by any one node in the blockchain network, is received, and the designated user identifier in the transfer-out block is an identifier of a user on the node, adding a rejection block corresponding to the transfer-out block onto the blockchain corresponding to the target virtual data carrier, and broadcasting a block addition message corresponding to the rejection block to the blockchain network.

Further, the data processing method further comprises: receiving a block addition message which corresponds to a transfer-out block with respect to the target virtual data carrier and is broadcast by any one node in the blockchain network; judging whether the block addition message corresponding to the transfer-out block comprises association information, and if so, determining, according to the association information, features of all association initiation blocks in a corresponding associating operation; and in a case of receiving all the association initiation blocks of the associating operation, adding an association completion blocks to ends of the blockchains corresponding to the virtual data carrier that a user of the node itself needs to receive, and broadcasting the association completion blocks.

Further, the data processing method further comprises: receiving a block addition message which corresponds to a payment block with respect to the target virtual data carrier and is broadcast by any one node in the blockchain network; and judging whether an amount of owner user identifiers is more than one in the block addition message corresponding to the payment block of the target virtual data carrier; and if so, determining, according to ownership contents of owner users corresponding to the respective owner user identifiers, whether the block addition message corresponding to the payment block is legitimate.

Further, the data processing method further comprises: adding a mortgage block into the blockchain of the target virtual data carrier; receiving a payment instruction sent by an owner user; adding, according to the payment instruction, a payment block into a blockchain of other target virtual data carrier, and adding a progression block behind the mortgage block, a serial number of the progression block being within a range set by the mortgage block, and doing not overlap with a serial number of other progression block added behind the mortgage block; and the payment block comprising a digital identifier of a target virtual data carrier to which the mortgage block belongs and comprises a serial number of a corresponding progression block; and broadcasting a block addition message corresponding to both the payment block and the progression block with respect to the target virtual data carrier in the blockchain network, so that other nodes in the blockchain network verify validity of the payment block and the progression block.

Further, the data processing method further comprises: if the serial number of the progression block exceeds the range of a preset serial number of an original mortgage block, replacing or re-creating a new mortgage block on another target virtual data carrier, and adding the progression block behind the new mortgage block; and broadcasting unowned-state information with respect to a virtual data carrier to which the original mortgage block belongs in the blockchain network, so that other users in the blockchain network compete for acquiring ownership of the virtual data carrier, to which the original mortgage block belongs, based on a preset rule.

Further, the data processing method further comprises: acquiring respective data character information, the data character information comprising any one item selected from the group consisting of an arbitrary face value of virtual currency, an arbitrary face value of legitimate currency, information of property of an arbitrary amount and content, information of raw material of an arbitrary content and quantity, information of an arbitrary person, and a transaction of an arbitrary content; creating, according to the respective data character information, respective virtual data carriers in one-to-one correspondence with the respective data character information and blockchains corresponding to the respective virtual data carriers, root blocks of the respective blockchains or virtual data carriers, to which the respective blockchains belong, both storing inherent information of a corresponding virtual data carrier; the inherent information comprising the data character information; and a digital identifier of the corresponding virtual data carrier is calculated through the inherent information, so that the digital identifier can verify the corresponding inherent information.

Further, in a case where the data character information is a transaction, the data processing method further comprises: creating a virtual data carrier storing a procedure or a rule of the transaction in inherent information, all participants of the transaction executing the transaction according to the procedure or the rule; the procedure or the rule comprising adding, by a participant, a change block to a blockchain corresponding to the virtual data carrier in a mode prescribed by the procedure or the rule, to modify contents of the procedure or the rule.

Further, in a case where the data character information is the arbitrary face value of virtual currency or legitimate currency, the data processing method further comprises: receiving an instruction, which is sent by an owner user, of creating a secondary virtual data carrier; freezing one or more of the virtual data carriers whose current owner user is the owner user; and creating at least one secondary virtual data carrier storing a designated face value, a total face value of the at least one secondary virtual data carrier being less than or equal to a total face value of the virtual data carriers.

Further, in a case where the data character information is information of raw materials or components of the arbitrary content and quantity, the data processing method further comprises: freezing a virtual data carrier whose data character information is the information of raw materials or components of the arbitrary content and quantity; and creating at least one secondary virtual data carrier storing a designated product, a sum of required raw materials or components required for a product of the secondary virtual data carrier being less than or equal to a sum of raw materials or components indicated by the data character information of the virtual data carrier.

Further, the data processing method further comprises: receiving mortgage information of a virtual data carrier mortgaged by other participants; and creating a fast channel between a participant on a current node and other participants who send out the mortgage information, the fast channel being a virtual data carrier whose data character information is a transaction, inherent information of the virtual data carrier comprising a plurality of participants, a settlement condition, and virtual data carriers mortgaged by the respective participants, so that any one participant adds a corresponding delivery block to an end of a blockchain of the fast channel when the participant plans to perform delivery with other participants.

In a second aspect, the present disclosure also provides a node, which comprises: a block addition message receiving module, configure to receive a block addition message which is with respect to a target virtual data carrier and sent by any one node in a blockchain network, the block addition message comprising a digital identifier corresponding to the target virtual data carrier, data change information, and an owner user identifier, the blockchain network comprising a plurality of virtual data carriers storing data character information, and each virtual data carrier being provided with a unique corresponding digital identifier and corresponding to at least one blockchain; a target blockchain information acquiring module, configured to acquire target blockchain information corresponding to the target virtual data carrier, according to the digital identifier corresponding to the target virtual data carrier; and a legitimacy judging module, configured to judge, based on data change history information, which is in the target blockchain information, of at least one block, whether the data change information in the block addition message is legitimate, and if legitimate, confirm the data change information in the block addition message.

In a third aspect, the present disclosure also provides a blockchain network, comprising a plurality of nodes.

In a fourth aspect, the present disclosure also provides a virtual data carrier, the virtual data carrier is configured to store data character information and provided with a unique digital identifier, each virtual data carrier corresponds to at least one blockchain; and respective blockchains all belong to the blockchain network.

In a fifth aspect, the present disclosure also provides an electronic device, comprising a memory, a processor, and a computer program stored on the memory and run on the processor; the processor, when executing the computer program, implements the data processing method.

In a sixth aspect, the present disclosure also provides a computer-readable storage medium, storing a computer program; the computer program, when executed by a processor, implements the data processing method.

It can be seen from the above-described technical solutions that, the present disclosure provides a data processing method, a node, a blockchain network, and a virtual data carrier, the data processing method, by receiving a block addition message which is with respect to a target virtual data carrier and sent by any one node in a blockchain network, the block addition message comprising a digital identifier corresponding to the target virtual data carrier, data change information, and an owner user identifier, the blockchain network comprising a plurality of virtual data carriers storing data character information, and each virtual data carrier being provided with a unique corresponding digital identifier and corresponding to at least one blockchain; acquiring target blockchain information corresponding to the target virtual data carrier, according to the digital identifier corresponding to the target virtual data carrier; and judging, based on data change history information, which is in the target blockchain information, of at least one block, whether the data change information in the block addition message is legitimate, and if legitimate, confirming the data change information in the block addition message, can simplify the data processing of the blockchain network and effectively improve the data processing efficiency of the blockchain network while ensuring the decentralization and security of the blockchain network, and can effectively lower power consumption for the data processing, and ensure the reliability of the data processing in the blockchain network.

### BRIEF DESCRIPTION OF THE DRAWINGS

In order to make objects, technical schemes and advantages of the embodiments of the present disclosure clearer, the technical scheme of the embodiments of the present disclosure will be described clearly and completely with reference to the drawings in the embodiments of the present disclosure. Obviously, the described embodiments are part of the embodiments of the present disclosure, not all of them. Based on the embodiments in the present disclosure, all other embodiments obtained by the ordinary technicians in this field without creative labor belong to the protection scope of the present disclosure.

FIG. 1 is a schematic flow chart of step 11 to step 13 in a data processing method according to an embodiment of the present disclosure;

FIG. 2 is a schematic diagram of an exemplary structure of a blockchain network according to an embodiment of the present disclosure;

FIG. 3 is a schematic diagram of an exemplary architecture of a virtual data carrier according to an embodiment of the present disclosure;

FIG. 4 is a schematic flow chart of the data processing method including step 41 according to the embodiment of the present disclosure;

FIG. 5 is a schematic flow chart of the data processing method including step 51 according to the embodiment of the present disclosure;

FIG. 6 is a schematic flow chart of step 61 to step 63 in a data processing method according to an embodiment of the present disclosure;

FIG. 7 is a schematic diagram of a first state of an ownership transfer process of a virtual data carrier according to an embodiment of the present disclosure;

FIG. 8 is a schematic diagram of a second state of the ownership transfer process of the virtual data carrier according to the embodiment of the present disclosure;

FIG. 9 is a schematic flow chart of a data processing method including step 91 according to an embodiment of the present disclosure;

FIG. 10 is a schematic flow chart of the data processing method including step 1001 according to the embodiment of the present disclosure;

FIG. 11 is a schematic flow chart of step 1101 and step 1102 of a data processing method according to an embodiment of the present disclosure;

FIG. 12 is a schematic flow chart of the data processing method including step 1201 and step 1202 according to the embodiment of the present disclosure;

FIG. 13 is a schematic flow chart of step 1301 to step 1303 in a data processing method according to an embodiment of the present disclosure;

FIG. 14 is a schematic flow chart of step 1401 and step 1402 in a data processing method according to an embodiment of the present disclosure;

FIG. 15 is a schematic flow chart of step 1501 to step 1503 in a data processing method according to an embodiment of the present disclosure;

FIG. 16 is a schematic flow chart of a data processing method including step 1601 according to an embodiment of the present disclosure;

FIG. 17 is a schematic flow chart of step 1701 and step 1702 in a data processing method according to an embodiment of the present disclosure;

FIG. 18 is a schematic flow chart of step 1801 and step 1802 in a data processing method according to an embodiment of the present disclosure;

FIG. 19 is a schematic flow chart of step 1901 and step 1902 in a data processing method according to an embodiment of the present disclosure;

FIG. 20 is a structural schematic diagram of a node according to an embodiment of the present disclosure; and

FIG. 21 is a structural schematic diagram of an electronic device according to an embodiment of the present disclosure.

### DETAILED DESCRIPTION

In order to make objects, technical schemes and advantages of the embodiments of the present disclosure clearer, the technical scheme of the embodiments of the present disclosure will be described clearly and completely with reference to the drawings in the embodiments of the present disclosure. Obviously, the described embodiments are just a part but not all of the embodiments of the present disclosure. Based on the described embodiments herein, those skilled in the art can obtain other embodiment(s), without any inventive work, which should be within the scope of the disclosure.

In the prior art, Proof of Work (POW) is a competition and consensus mechanism adopted by many cryptocurrencies represented by Bitcoin. Taking competitive account-keeping of Bitcoin as an example, in order to select a user to keep the account, competing nodes in the blockchain network are required to acquire a piece of target data, add the target data into ledger data to be hashed together, and enable a calculation result to be less than a preset value. It can be understood that, the result of hash operation is unpredictable, so the desired target data cannot be obtained by a simple calculation, but only by testing with different data until qualified data is obtained. A first node that obtains the target data is authorized to record the block and get corresponding reward; while other nodes that fail to obtain will not get any reward. In other words, every time an account of a block is recorded, many competing nodes have to execute hash operation repeatedly, and this process will cause a lot of power consumption.

Cryptocurrency is a transaction medium that ensures transaction security and controls creation of transaction units on cryptography principles. Cryptocurrency is a type of digital currency (or referred to as virtual currency). Bitcoin is a first decentralized cryptocurrency; and thereafter the term “cryptocurrency” mostly refers to such type of design. Cryptocurrency is based on a decentralized consensus mechanism, as opposed to a banking financial system that relies on a centralized regulatory system.

The current cryptocurrency represented by Bitcoin has not been able to achieve three objectives, that is, decentralization, security, and low power consumption at a same time. As far as Bitcoin is concerned, although Bitcoin has basically met user application needs in terms of decentralization and security, competition and consensus mechanism, such as proof of work, applied thereby in data processing will waste a lot of time and electric power.

With respect to other cryptocurrencies that have consensus reached in other modes, energy consumption is reduced at the expense of loss of decentralization which is an important indicator.

By deeply exploring the cause, it can be known that, with respect to the above-described cryptocurrency, all payment records are saved on a same blockchain, all transaction records in a time period are saved by a certain user as a block, and the block is added to the end of the blockchain. The user who executes the operation may get a certain amount of reward (which is the only way to create Bitcoin) and has opportunities to cheat. Therefore, everyone wants to have power to keep accounts, and a candidate for account-keeping has to be determined through competition; after the account is recorded, if others do not agree with the account, a consensus has to be reached again through a complicated set of procedures; and the POW mechanism plays a key role in both competing in account-keeping and reaching a consensus, which wastes a lot of power.

In final analysis, keeping all operation records in the blockchain network on a same blockchain is still essentially an idea relying on centralization.

Considering that all operation records in the blockchain network are saved on a same blockchain, so that the respective nodes have to get permission to add blocks through the competition and consensus mechanism, such as proof of work, and after receiving a block addition message broadcast, the respective nodes also have to reach a consensus on the block addition message with other nodes through the competition and consensus mechanism, such as proof of work, which further causes the problem of complex, time-consuming and power-consuming data processing of the existing blockchain network, the present disclosure provides a data processing method, a node, a blockchain network, a virtual data carrier, an electronic device, and a computer-readable storage medium, in which, a block addition message which is with respect to a target virtual data carrier and sent by any one node in the blockchain network is received by a certain node in the blockchain network, the block addition message comprises a digital identifier corresponding to the target virtual data carrier, data change information, and an owner user identifier; the blockchain network comprises a plurality of virtual data carriers storing data character information and each virtual data carrier is provided with a unique corresponding digital identifier, and each of the virtual data carriers corresponds to at least one blockchain; according to the digital identifier corresponding to the target virtual data carrier, target blockchain information corresponding to the target virtual data carrier is acquired; based on data change history information of at least one block in the target blockchain information, whether the data change information in the block addition message is legitimate is judged; and if so, the data change information in the block addition message is confirmed; the present disclosure can simplify data processing of the blockchain network while ensuring decentralization and security of the blockchain network, effectively improve data processing efficiency of the blockchain network, lower power consumption for data processing, and ensure reliability of data processing in the blockchain network. Specifically, the above are respectively described through a plurality of embodiments and application examples below.

Based on the above-described contents, because after the respective nodes receive the block addition message broadcast, if there is a node believing that the block addition message is illegitimate, it also needs to reach a consensus on illegitimacy with other nodes through a competition and consensus mechanism, such as proof of work; the present disclosure provides a data processing method, a node, a blockchain network, a virtual data carrier, an electronic device, and a computer-readable storage medium, in which, when or after a certain node in the blockchain network determines the data change information in the block addition message is illegitimate, if the operation on the data change information is determined to belong to one of preset operations with serious circumstances, then an illegitimate authority declaration block is added into target blockchain information corresponding to all virtual data carriers of which the owner user is a target user who executes the operation on data change information, and is broadcast, so that other nodes in the blockchain network refuse to verify an ownership transfer block added by the target user onto the virtual data carrier onto which the illegitimate authority declaration block is added, to further comprehensively simplify data processing of the blockchain network.

In one or more embodiments of the present disclosure, the blockchain network comprises a plurality of virtual data carriers storing the data character information, each virtual data carrier is provided with a unique identifier, and each of the virtual data carriers corresponds to at least one blockchain.

The data character information includes any one item selected from the group consisting of an arbitrary face value of virtual currency, an arbitrary face value of legitimate currency, information of property of an arbitrary amount and content, information of raw material of an arbitrary content and quantity, information of an arbitrary person, and a transaction of an arbitrary content.

Root blocks of the respective blockchains or virtual data carriers to which the blockchain belongs both store corresponding inherent information of the virtual data carrier; the inherent information comprises the data character information; and a digital identifier of the corresponding virtual data carrier is calculated through the inherent information, so that the digital identifier can verify the corresponding inherent information.

Specific instructions are as follows.

The virtual data carrier is a data structure used to record an object. The object that the virtual data carrier records may be a fixed amount of cryptocurrency, or may also be extended to a wider range, such as a legitimate currency, property, a commodity, a person, a transaction, etc. By recording everything with a virtual data carrier, there is a world that can be queried, traced, and trusted. Data of an object is divided into two portions, i.e., the foregoing inherent information and variable information; the inherent information is hashed or signed to obtain a digital identifier; the digital identifier may verify the inherent information; a change history of variable information of an object is recorded with a blockchain of each virtual data carrier; and a block is added to the blockchain every time there is a change. The variable information includes ownership of an object. In the case where the variable information is in different states, each person has different addition permissions with respect to each type of block, especially, a change in ownership affects addition permissions of various blocks.

With one blockchain, each virtual data carrier can already meet needs of recording variable information. Based on specific implementation needs, there may also be a case where more than one blockchain are set for each virtual data carrier, which also falls within the protection scope of the present disclosure.

The recorded object should have atomicity, and are inseparable during a recording period; the recorded object may be similar to a packed bag of rice, but never be a pile of loose rice unpacked.

1. In the case where the object is legitimate currency or other property, a use mode of the virtual data carrier is similar to a use mode in the case where the object is cryptocurrency; and each virtual data carrier represents a piece of fixed property.

2. In the case where the object is a commodity, inherent information of the virtual data carrier indicates producer, date of production, place of production, model, raw material, process, serial number, etc., of the commodity. For example, the object is a ballpoint pen, a corresponding virtual data carrier is created once the ballpoint pen is produced; serial numbers of a same batch of products are different, and generated digital identifiers of the same batch of products are also different. Then, ten pens are packaged into a box, and a virtual data carrier is also created for the box; a blockchain of the ten pens in the box, each pen corresponds to a block added thereto, which indicates that variable information of the pen hereafter is entrusted to the box. Several boxes are packed into one case, and variable information of each box is also entrusted to the case. The case is shipped to a wholesaler, resulting in a change in location, and a change in ownership, which only need to be recorded on a blockchain of the case.

The wholesaler unpacks the case, adds another block to a blockchain of each box, the entrusted relationship between the box and the case is released, and copying a variable information end state of the case onto the box. Distributing the box to a retailer changes ownership of the box, and then the retailer opens the box, the entrusted relationship between the pen and the box is released. In the case where the pen is sold to a customer, the ownership of the pen is transferred to the customer.

If the transaction is performed with a virtual data carrier whose object is currency, a purchase process is simplified as an associating operation, which is that a buyer transfers ownership of several virtual data carriers whose object is currency to a seller in exchange for ownership of several virtual data carriers whose object is commodity.

3. When the object is a person, inherent information of a virtual data carrier indicates contents, such as the person's birth time and place, parental status, gender, race, characteristics, DNA profile, etc., and then events, large or small, in his/her life are recorded on the blockchain as variable information. For example, when a child goes to elementary school, the school is authorized to record certain types of blocks, and deauthorized after he/she leaves school.

4. When the object is a transaction, inherent information of a virtual data carrier indicates the transaction's type, procedure, initial condition, expected progress, etc., and then execution of each step is recorded as variable information in the blockchain. For example, when a user applies for a patent at a Patent Office, an application procedure and initial application documents are put in inherent information; after adding a submission application block, the user is authorized to add a withdrawal block, and the Patent Office is authorized to add an acceptance block; after acceptance, the user is authorized to add a payment block; after payment, the Patent Office is authorized to add a preliminary review block; if receiving no payment over time, the Patent Office is authorized to add a deemed withdrawal block, . . . , and all steps run according to the application procedure recorded in the inherent information. The procedure may be written in a programming language or markup language, describing all states of the entire procedure and state jumps triggered in response to each event in each state is essentially a smart contract that can guide all participating parties to execute the procedure step by step.

If the procedure changes during execution of the transaction (e.g., the patent law is revised), there are two processing modes: a) adding a new procedure as a special block onto the blockchain; and b) creating a new virtual data carrier, stating the new procedure and a relationship thereof with the original virtual data carrier in the inherent information, and suspending execution of the original virtual data carrier.

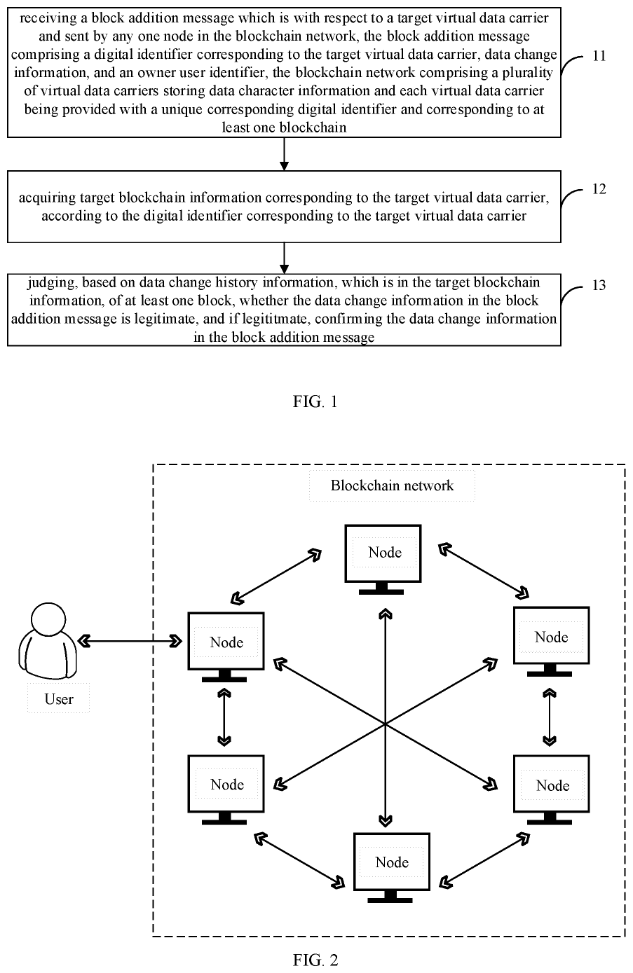

In order to simplify data processing of the blockchain network and improve efficiency of legitimacy judgment in data transmitting, to effectively improve data processing efficiency of the blockchain network, while ensuring decentralization and security of the blockchain network, and effectively lower power consumption for data processing, the present disclosure provides a data processing method embodiment in which an executive subject is any one node in a blockchain network; and referring to FIG. 1, the data processing method specifically comprises the following contents.

Step 11: receiving a block addition message which is with respect to a target virtual data carrier and sent by any one node in the blockchain network, the block addition message comprising a digital identifier corresponding to the target virtual data carrier, data change information, and an owner user identifier, the blockchain network comprising a plurality of virtual data carriers storing data character information and each virtual data carrier being provided with a unique corresponding digital identifier and corresponding to at least one blockchain.

It can be understood that, any one node in the blockchain network sends the block addition message with respect to the target virtual data carrier in a manner of broadcast to other nodes in the blockchain network, the term “broadcast” may not only refer to directly sending, by a source node, a message to all the other nodes, but also refer to sending, by a source node, a message to some of the other nodes, and forwarding, by each node that receives the message, the message to more nodes, and relaying in such a manner repeatedly, so as to achieve a broadcasting effect globally.

In one or more embodiments of the present disclosure, referring to FIG. 2, each node is a full-fledged member in the blockchain network, and belongs to a logical node; in addition, a node may be either a client or a server; each node has a routing function, but does not necessarily have all other functions; and different types of nodes may only include some functions. The blockchain network is a peer-to-peer (P2P) network including a plurality of nodes. It can be understood that, there is a non-fixed one-to-one or non-fixed one-to-many relationship between node and user, the non-fixed relationship corresponds to a case where a certain user borrows a node corresponding to another person to operate his/her own account.

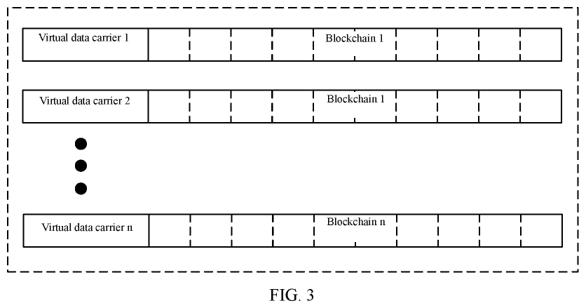

In one or more embodiments of the present disclosure, a blockchain network comprises a plurality of virtual data carriers belonging to respective users; referring to FIG. 3, each virtual data carrier corresponds to at least one blockchain; the virtual data carrier is used for storing data character information and is provided with a unique corresponding digital identifier; the data character information is one type of the foregoing inherent information, that is, a unique and fixed meaning represented by a corresponding virtual data carrier itself; and a digital identifier is an identifier voucher of the unique and fixed meaning represented by the virtual data carrier.

In step 11, a node in the blockchain network receives the block addition message which is with respect to the target virtual data carrier and is broadcast by any one node in the same blockchain network, and reads the digital identifier corresponding to the target virtual data carrier, the data change information, and the owner user identifier contained in the block addition message. The target virtual data carrier is just any one of the plurality of virtual data carriers in the current blockchain network.

It can be understood that, the data change information comprises a specific change content; or may also contain an identifier of an original owner user of the blockchain or the virtual data carrier before change and an identifier of a designated user of the blockchain or the virtual data carrier after change; or may also contain contents, such as change operation time information.

Moreover, the owner user identifier is a digital identifier used to identify respective users in the current blockchain network.

Step 12: acquiring target blockchain information corresponding to the target virtual data carrier, according to the digital identifier corresponding to the target virtual data carrier.

In step 12, because in the blockchain network, all virtual data carriers and the blockchains corresponding the virtual data carriers are public storage information, that is, any node may maintain and/or query any one virtual data carrier and blockchain information corresponding the virtual data carrier at any time, the node that receives the block addition message may, according to the digital identifier corresponding to the target virtual data carrier in the block addition message, search to obtain the target virtual data carrier and unique blockchain information corresponding the target virtual data carrier in the pre-stored entire virtual data carrier information.

Step 13: judging, based on data change history information, which is in the target blockchain information, of at least one block, whether the data change information in the block addition message is legitimate, and if legitimate, confirming the data change information in the block addition message.

In step 13, after finding the target blockchain information corresponding to the target virtual data carrier in a mode of step 12, the node that receives the block addition message matches the data change information in the block addition message with data change history information of at least one block in the target blockchain information. If matching succeeds, the data change information in the block addition message is considered legitimate. It can be understood that, the confirming the data change information in the block addition message may be voluntarily marking the data change information in the block addition message as legitimate.

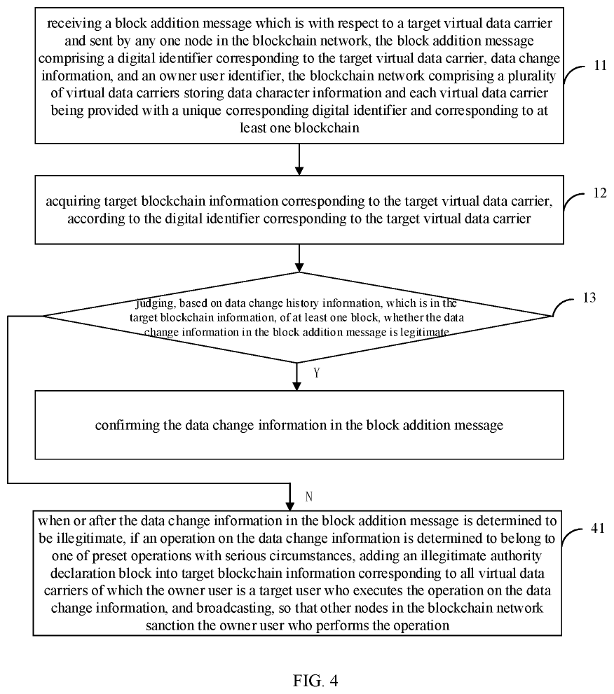

In order to further comprehensively simplify data processing of the blockchain network to improve efficiency of legitimacy judgment in data transmitting, after the above-described step 13 in the data processing method embodiment of the present disclosure, referring to FIG. 4, if the data change information in the block addition message is illegitimate, the following step 41 is executed, step 41 specifically includes the following contents.

Step 41: when or after the data change information in the block addition message is determined to be illegitimate, if an operation on the data change information is determined to belong to one of preset operations with serious circumstances, adding an illegitimate authority declaration block into target blockchain information corresponding to all virtual data carriers of which the owner user is a target user who executes the operation on the data change information, and broadcasting, so that other nodes in the blockchain network sanction the owner user who performs the operation.

It can be understood that, the preset operations with serious circumstances are operations with a higher level of violation among violating operation specifications pre-set by the corresponding blockchain network; specifically, the operations with serious circumstances at least include a situation of adding a plurality of blocks, such as ownership transfer/freezing/mortgage/association initiation, or a combination of the above-described several blocks in a same position of a blockchain, thereby causing a state of the blockchain to be not unique.

In step 41, after finding the target blockchain information corresponding to the target virtual data carrier in a mode of step 12, the node that receives the block addition message matches the data change information in the block addition message with data change history information of at least one block in the target blockchain information; if matching fails, the data change information in the block addition message is considered illegitimate.

It can be understood that, an example of the matching procedure may be exemplified as follows.

It is assumed that the data change information in the current block addition message includes: “specific change content: ownership transfer; identifier of original owner user of block or virtual data carrier before change: A; identifier of designated user of block or virtual data carrier after change: B; change time: 03:31:40 am, Dec. 1, 2018”; and data change history information of a historical last block of the target blockchain information is “specific change content: unfreezing; identifier of owner user who adds contents: A; change time: 04:06:24 pm, Nov. 11, 2018”; then the data change information in the block addition message is matched with the data change history information according to a preset matching rule; and the preset matching rule is preset according to information, such as the content represented by the virtual data carrier and the content of the consensus mechanism of the blockchain network.

TABLE 1

| | | Identifier of | Identifier of | |
|---|---|---|---|---|
| | | original owner | designated | |
| | | user of block | user of block | |
| | Specific | or virtual data | or virtual data | |
| | change | carrier before | carrier after | |
| | content | change | change | Change time |
| Data change | Ownership | A | B | 03:31:40 am, |
| information in | transfer | | | Dec. 01, |
| block addition | | | | 2018 |
| message | | | | |
| Data change | Unfreezing | A | | 04:06:24 pm, |
| history | | | | Nov. 11, |
| information of | | | | 2018 |
| historical last | | | | |
| block | | | | |
| Matching | No conflict | No conflict | No conflict | No conflict |
| result | | | | |

In the example, referring to the above-described Table 1, a matching result between the data change information in block addition message and the data change history information of historical last block shows that, the identifier of the original owner user in the data change information in the block addition message is the same as the identifier of the owner user in the data change history information; the specific change content has no conflict; and the change time in the data change information in the block addition message is later than the change time in the data change history information; so by matching with the data change history information of the historical last block in the target blockchain information, it can be seen that, data between the data change information in the block addition message and the data change history information of the last block in the target blockchain information matches each other; thereafter, data change history information of a penultimate block may continue to be traced back; if no unmatched data is discovered until traversing to the root block, the data change information in the block addition message is determined to be legitimate; conversely, if data is discovered unmatched in data change history information of the last block for the first time, the data change information in the block addition message may be determined to be illegitimate through only one match.

The node that determines the operation on the data change information to belong to one of the preset operations with serious circumstances will add an illegitimate authority declaration block into the target blockchain information corresponding to all virtual data carriers of which the owner user is the target user who executes the operation on the data change information; and thereafter, the node will broadcast the block addition message with respect to the illegitimate authority declaration block in the entire blockchain network, so that other nodes will sanction the owner user who performs the operation, according to the block addition message with respect to the illegitimate authority declaration block.

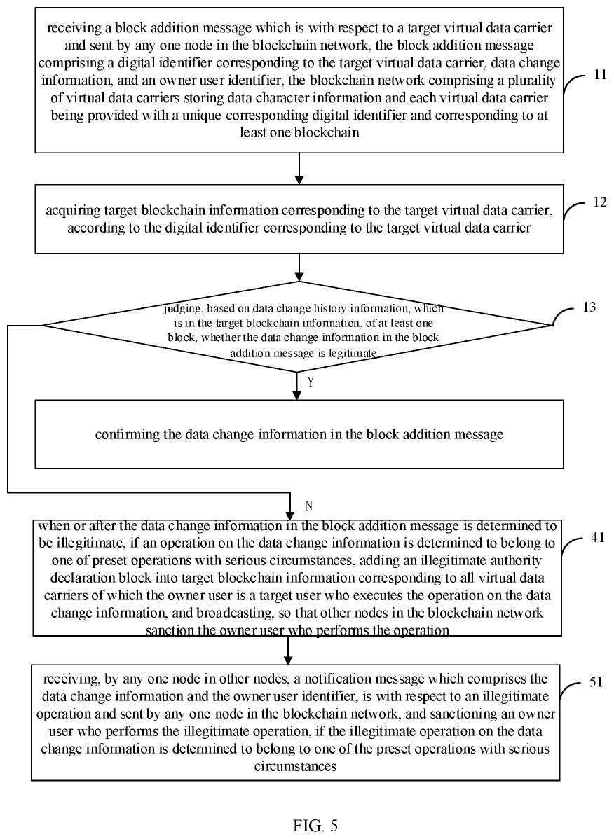

Based on the above-described content, referring to FIG. 5, the data processing method specifically comprises the following contents.

Step 51: receiving, by any one node in other nodes, a notification message which comprises the data change information and the owner user identifier, is with respect to an illegitimate operation and sent by any one node in the blockchain network, and sanctioning an owner user who performs the illegitimate operation, if the illegitimate operation on the data change information is determined to belong to one of the preset operations with serious circumstances.

In the above description, the sanctioning the owner user who performs the illegitimate operation may specifically be: refusing to verify the ownership transfer block added by the target user onto the virtual data carrier onto which the illegitimate authority declaration block is added; and the sanctioning the owner user who performs the illegitimate operation may further specifically be: 1. rejecting any block added by the user on all blockchains; 2. rejecting ownership transfer with the user; 3. charging additional fees for ownership transfer involving the user; and 4. requiring the user to pay certain properties or execute designated transactions in exchange for lifting the sanction.

It can be seen from the above-described content that, the data processing method provided by the embodiment of the present disclosure, by setting the virtual data carriers to enable each virtual data carrier to correspond to at least one blockchain, so that respective nodes only need to voluntarily verify legitimacy of the node without reaching a consensus with other respective nodes through the competition and consensus mechanism, such as proof of work, and broadcast after verification, can effectively simplify data processing of the blockchain network while ensuring decentralization and security of the blockchain network, and can effectively lower power consumption for data processing.

Based on the above-described content, if the data character information of the virtual data carrier is an arbitrary face value of cryptocurrency, then in an application example of the present disclosure, the data processing method may further effectively prevent a double-spend attack; and details are described as follows.

Double spend refers to paying the same single digital asset respectively to a plurality of users, which is a common attack method against cryptocurrency. With respect to a virtual data carrier representing an arbitrary face value of cryptocurrency, double-spend may only be addition of a plurality of payment blocks to a same position on the blockchain by a current owner user of the virtual data carrier, thereby causing the blockchain to fork. Because all changes in the blockchain must be broadcast to all nodes, even if the adder sends the payment block to a receiver of the paying virtual data carrier in a non-broadcast manner, the receiver must also broadcast when receiving the block; once double spend occurs, it will be immediately discovered by other users from the broadcast. The discoverer broadcasts two or more blocks at the fork to all nodes; and the blocks are all signed, so that the double-spend perpetrator cannot deny and is immediately sanctioned by the entire network. With respect to each remaining virtual data carrier of the double-spend perpetrator, the discoverer may add a block to the end of the blockchain of each remaining virtual data carrier, and write the forking blocks to the block added in the end of the blockchain to enable the remaining virtual data carriers in an unowned state.

If account creation is free, an attacker may launch a double-spend attack at the cost of an account. In this regard, there are strategies as follows.

1. Charging for account creation, which specifically includes two solutions that: a. each newly created account must pay a certain fee before the newly created account can be paid to others normally; and b. POW must be required for a user to create an account, thus charging some electricity each time.

2. Forcing a user to pay in series when paying a plurality of virtual data carriers, that is, one payment must be completed before a next payment, so as to increase risks of cheating.

3. Dividing each payment into two steps. After receiving a transfer-out block of a payer node, a receiver node waits for some time, and adds an acceptance block only when the receiver node discovers no conflicting information. During the waiting time, the transfer-out block of the payer node is already spread across the entire network; if hereafter, the payer node sends out another transfer-out block at a same position on the blockchain, not only will its own account be sanctioned, but a new transfer-out block must also be rejected by the entire network without affecting a previous payment.

In the application documents of the present disclosure, the “transfer-out block” specifically refers to a block added by the payer in the first step of the two-step paying mode; and the “payment block” or the “ownership transfer block” not only includes the transfer-out block, but also includes a block added by the payer in a single-step paying mode.

In an extreme situation, user A firstly adds a block, which is transferred to user B, on a blockchain of a virtual data carrier, after user B receives the block, user A also adds a block which is transferred to user C at a same position of the blockchain without broadcasting; and it is not until user C transfers the virtual data carrier to user D that the entire network discovers the double-spend event. If the transfer process from user A to user C is even unknown to a long-term online node, it indicates that user C did not broadcast according to rules when receiving the virtual data carrier, so user C may be regarded as an accomplice of user A and sanctioned. No matter how long the fork from user A to user C is, as long as an owner user therein finally tries to pay the virtual data carrier to a normal user, once it is broadcast by a normal node, the entire network may discover and handle the abnormal fork, and sanction all users who violate the rules.

As described above, a long-term online normal node must be able to distinguish authenticity of two branches. While a non-long-term online node who has difficulties to distinguish authenticity may simply reject all forking virtual data carriers, or require the payer to pay extra fees for the fork, for example, to use a virtual data carrier with a face value of ten yuan as that with a face value of six yuan. Because the double-spend attacker cannot gain, but lose an account, the number of forking blocks is bound to be small.

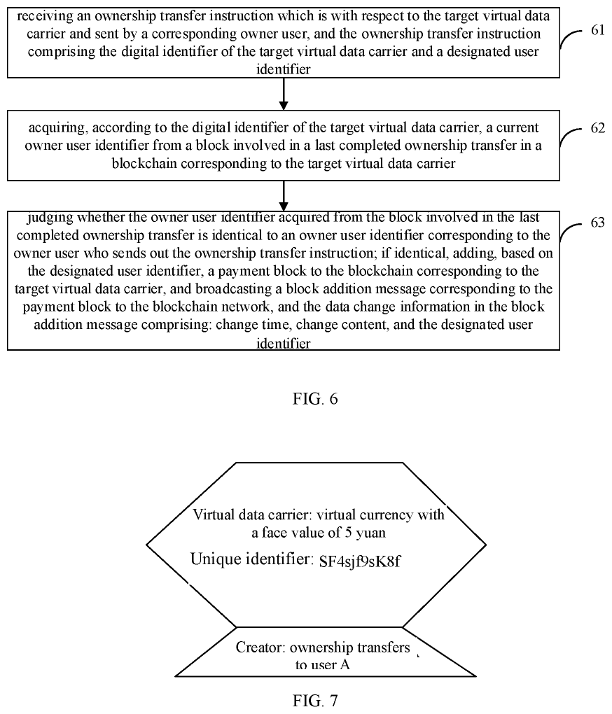

In order to simplify the ownership transfer process of a virtual data carrier, to further effectively improve data processing efficiency of the blockchain network while ensuring decentralization and security of the blockchain network, and effectively lower power consumption for data processing, the present disclosure provides a data processing method embodiment in which an executive subject is any one node in a blockchain network; and referring to FIG. 6, the data processing method specifically comprises the following contents.

Step 61: receiving an ownership transfer instruction which is with respect to the target virtual data carrier and sent by a corresponding owner user, and the ownership transfer instruction comprising the digital identifier of the target virtual data carrier and a designated user identifier.

It can be understood that, a node in the blockchain network may receive the ownership transfer instruction with respect to the target virtual data carrier from other authorized terminal device in a communicative connection, so the step may be receiving the ownership transfer instruction with respect to the target virtual data carrier directly input by the authorized user in the node.

Step 62: acquiring, according to the digital identifier of the target virtual data carrier, a current owner user identifier from a block involved in a last completed ownership transfer in a blockchain corresponding to the target virtual data carrier.

It can be understood that, with respect to each virtual data carrier, current owner user information of the virtual data carrier may be acquired from related information of a last completed ownership transfer process on the blockchain corresponding to the virtual data carrier. One ownership transfer process will have a target user identifier recorded in one or more blocks; after ownership transfer is completed, the target user of ownership transfer becomes a new owner user. Therefore, the target user read from the block involved in the last completed ownership transfer is the current owner user.

Step 63: judging whether the owner user identifier acquired from the block involved in the last completed ownership transfer is identical to an owner user identifier corresponding to the owner user who sends out the ownership transfer instruction; if identical, adding, based on the designated user identifier, a payment block to the blockchain corresponding to the target virtual data carrier, and broadcasting a block addition message corresponding to the payment block to the blockchain network, and the data change information in the block addition message comprising: change time, change content, and the designated user identifier.

It can be seen from the above description that, the data processing method provided by the embodiment of the present disclosure, by setting a characteristic that only the owner user can operate the block of the virtual data carrier that has an authority transfer function, can simplify the ownership transfer process of the target virtual data carrier, and can effectively improve efficiency, security and reliability of ownership transfer of the target virtual data carrier.

Based on the above-described contents, if data character information of the virtual data carrier is an arbitrary face value of virtual currency, in an application example of the present disclosure, the data processing method can also effectively implement ownership transfer of the virtual data carrier in one step, and details are described as follows.

The block involved in the last completed ownership transfer of blockchain corresponding to the virtual data carrier indicates that the virtual data carrier belongs to user A.

User A is authorized to add a block, signs the block with his/her own private key, transfers the virtual data carrier to user B, and broadcasts update of the blockchain of the virtual data carrier to the entire network.

User B receives the broadcast, firstly verifies inherent information, such as a face value, by using the digital identifier of the virtual data carrier, then verifies all blocks in the blockchain of the virtual data carrier, and broadcasts an alarm to the entire network if there is an abnormality.

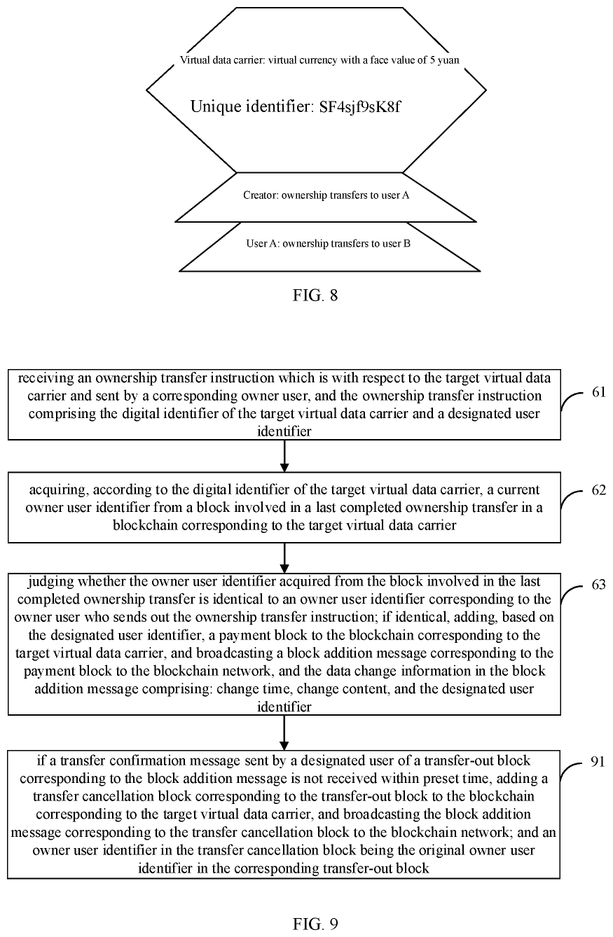

As shown in FIG. 7 and FIG. 8, a simplest virtual data carrier ownership transfer process is described; a last block of the blockchain of the virtual data carrier in FIG. 7 indicates that the virtual data carrier belongs to user A, so user A is authorized to add a block, signs the block with his/her own private key, transfers the virtual data carrier to user B, and broadcasts update of the blockchain of the virtual data carrier to the entire network. User B receives the broadcast, firstly verifies inherent information, such as a face value, by using the digital identifier of the virtual data carrier, then verifies all blocks in the blockchain of the virtual data carrier, and broadcasts an alarm to the entire network if there is an abnormality.

The above-described process may be specifically described as follows.

1. An original owner of a virtual data carrier is user A, and a user public key of user A is visible in a first block of the blockchain of the virtual data carrier.

2. User A adds a payment block to the end of the blockchain of the virtual data carrier, indicating that the virtual data carrier is transferred to user B (with a public key), signs the block with his/her own private key, and broadcasts to the public.

3. User B adds a payment block to the end of the blockchain of the virtual data carrier, indicating that the virtual data carrier is transferred to user C (with a public key), signs the block with his/her own private key, and broadcasts to the public.

4. User A adds a payment block to the end of the blockchain of the virtual data carrier, indicating that the virtual data carrier is transferred to user D (with a public key), signs the block with his/her own private key, and broadcasts to the public.

5. Everyone may verify ownership of the virtual data carrier: it is known from the first block that the owner at that time is user A, the latest payment block below is verified with the public key of user A, if passed, the payment block added in step 2 is legitimate; it is known from the block added in step 2 that the owner at that time is user B, the latest payment block below is verified with the public key of user B, if passed, the payment block added in step 3 is legitimate; and it is known from the block added in step 3 that the owner at that time is user C, the latest payment block below is verified with the public key of user C, if failed, the payment block added in step 4 is illegitimate. The virtual data carrier still belongs to user C.

In order to further improve efficiency of operations after the ownership transfer of the virtual data carrier fails or is cancelled, and further effectively lower power consumption for data processing, the present disclosure provides a data processing method embodiment in which an executive subject is an arbitrary node in a blockchain network; and referring to FIG. 9, the data processing method specifically comprises contents as follows.

After step 63, the method further comprises step 91: if a transfer confirmation message sent by a designated user of a transfer-out block corresponding to the block addition message is not received within preset time, adding a transfer cancellation block corresponding to the transfer-out block to the blockchain corresponding to the target virtual data carrier, and broadcasting the block addition message corresponding to the transfer cancellation block to the blockchain network; and an owner user identifier in the transfer cancellation block being the original owner user identifier in the corresponding transfer-out block.

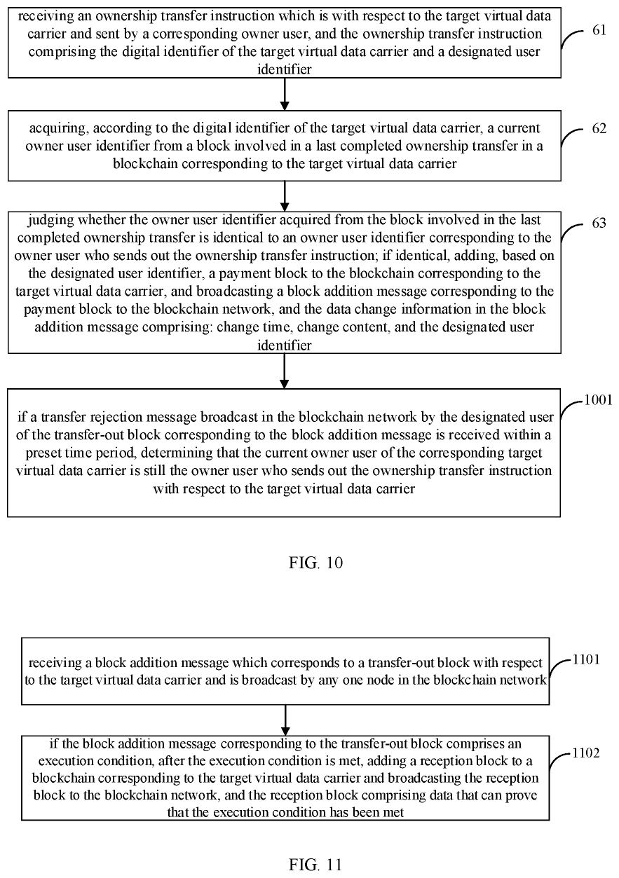

Referring to FIG. 10, after step 63, the method further comprises step 1001: if a transfer rejection message broadcast in the blockchain network by the designated user of the transfer-out block corresponding to the block addition message is received within a preset time period, determining that the current owner user of the corresponding target virtual data carrier is still the owner user who sends out the ownership transfer instruction with respect to the target virtual data carrier.

In other words, the payment operation may be divided into two or more steps. For example, in the case where user A pays a virtual data carrier to user B, user A firstly adds a transfer-out block to the blockchain of the virtual data carrier to indicate the transfer to user B; and user B may choose to accept or reject the virtual data carrier. If rejected, user A may still transfer the virtual data carrier to user B or other again. In the case where user B does not respond over a certain time period, user A is authorized to cancel the transfer. Transfer-out, acceptance, rejection, and cancellation are also executed by adding blocks to the end of the blockchain.

A state transition process of the virtual data carrier that allows block addition may specifically include contents as follows.

1. In an initial state, the virtual data carrier belongs to user A. User A is authorized to add a transfer-out block;

2. User A adds the transfer-out block, and indicates to transfer to user B. User B is authorized to add an acceptance block or a rejection block;

3. User B adds an acceptance block, and the virtual data carrier becomes owned by user B. User B is authorized to add a transfer-out block;

4. After step 2, user B adds a rejection block, and the state returns to step 1.

5. After step 2, user B has no operation till timeout, and user A is authorized to add a cancellation block; and

6. After step 5, user A adds a cancellation block, and the state returns to step 1.

In order to add an execution condition to improve reliability of ownership transfer of the virtual data carrier, and to further improve data processing security of the blockchain network, the present disclosure provides a data processing method embodiment in which an executive subject is an arbitrary node in a blockchain network; and referring to FIG. 11, the data processing method specifically comprises contents as follows.

Step 1101: receiving a block addition message which corresponds to a transfer-out block with respect to the target virtual data carrier and is broadcast by any one node in the blockchain network;

Step 1102: if the block addition message corresponding to the transfer-out block comprises an execution condition, after the execution condition is met, adding a reception block to a blockchain corresponding to the target virtual data carrier and broadcasting the reception block to the blockchain network, and the reception block comprising data that can prove that the execution condition has been met.

In other words, in the case where a block is added onto the blockchain of the virtual data carrier, the execution condition for the operation may be written in, and the operation is executed only in the case where the condition is met. For example, the execution condition is that: after 24 hours, if a total amount of virtual data carrier owned by a payer exceeds 100 yuan, the payment will be made, otherwise, cancelled. In the case where the receiver does not respond over a certain time period, the payer is authorized to cancel the transfer.

The execution condition provided by the present disclosure is exemplified below: user A adds a block x onto a blockchain of a virtual data carrier A1 he/she owns: “if a total amount of virtual data carrier, which I own, exceeds 100 yuan at 12 noon tomorrow, I will give the virtual data carrier A1 to user B”. A little later than the agreed time (so that there is enough time to receive the broadcast if the blockchain of the virtual data carrier held by user A changes), if user B learns that the the virtual data carrier owned by user A exceeds 100 yuan, user B may receive the virtual data carrier A1 by writing ownership information of the virtual data carrier into the reception block and adding the reception block behind the block x.

If user A transfers one of the virtual data carriers of user A to other person after 12 o'clock, but writes payment time as before 12 o'clock, because it is too long from the payment time to the broadcast time, the transfer will be judged invalid or even sanctioned by respective online nodes. The “judgment” by the respective nodes is no longer seeking a consensus in some way, but making their own respective judgments, that is, if one user believes that user A constitutes cheating, the user, who believes that user A constitutes cheating, may voluntarily decide how to handle.

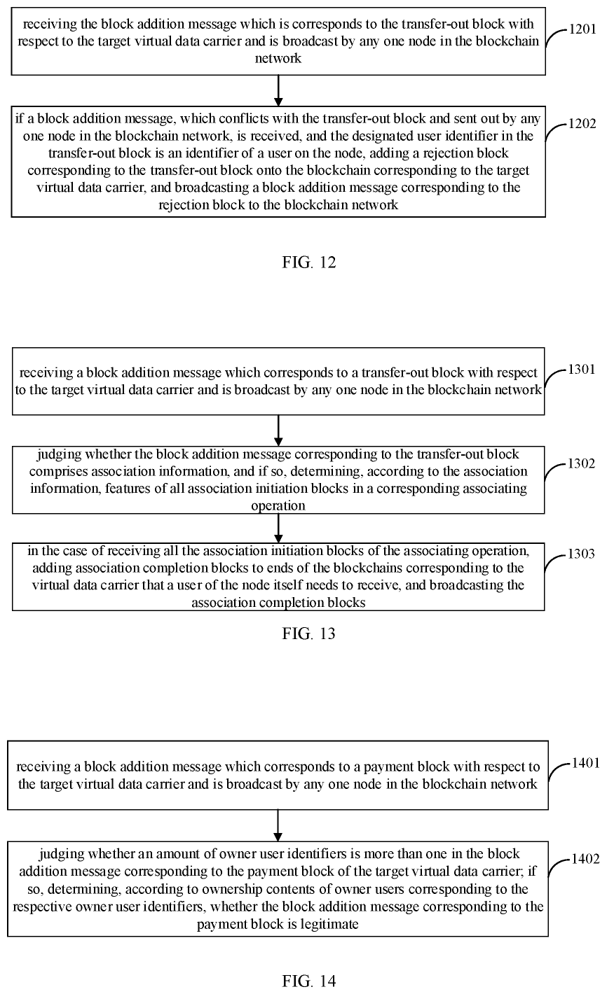

Based on the above-described contents, in a specific embodiment, referring to FIG. 12, the data processing method may further specifically comprise contents as follows.

Step 1201: receiving the block addition message which is corresponds to the transfer-out block with respect to the target virtual data carrier and is broadcast by any one node in the blockchain network.

Step 1202: if a block addition message, which conflicts with the transfer-out block and sent out by any one node in the blockchain network, is received, and the designated user identifier in the transfer-out block is an identifier of a user on the node, adding a rejection block corresponding to the transfer-out block onto the blockchain corresponding to the target virtual data carrier, and broadcasting a block addition message corresponding to the rejection block to the blockchain network.

In order to introduce payment association to improve reliability of ownership transfer of the virtual data carrier, to further improve data processing security of the blockchain network, the present disclosure provides a data processing method embodiment in which an executive subject is any one node in a blockchain network; and referring to FIG. 13, the data processing method specifically comprises contents as follows.

Step 1301: receiving a block addition message which corresponds to a transfer-out block with respect to the target virtual data carrier and is broadcast by any one node in the blockchain network.

Step 1302: judging whether the block addition message corresponding to the transfer-out block comprises association information, and if so, determining, according to the association information, features of all association initiation blocks in a corresponding associating operation.

Step 1303: in the case of receiving all the association initiation blocks of the associating operation, adding association completion blocks to ends of the blockchains corresponding to the virtual data carrier that a user of the node itself needs to receive, and broadcasting the association completion blocks.

It can be understood that, a plurality of payments may be associated together; the associated payments have to be simultaneous completed or cancelled; and a situation that some are completed and the others cancelled is not allowed. A plurality of payments may be associated together during payment. For example, in the case where user A pays 10 yuan to user B and asks user B to make change of 3 yuan, the two payments may be associated together, and required to be completed or cancelled only simultaneous; however, a situation that one payment is completed and the other cancelled is not allowed. For another example, if user A has to pay user B 7 yuan in virtual currency, but does not have a virtual data carrier with a face value of 7 yuan, user A may pay user B virtual data carriers of one 5 yuan and one 2 yuan, or may also pay user B a virtual data carrier of one 10 yuan and require user B to give a 3 yuan change.

On such basis, the present disclosure provides an application example of a specific solution for the associating operation as follows.

The associating operation is essentially exchange or simultaneous transfer of ownership of several virtual data carriers, which may be used for making change between virtual data carriers, or may also be applied to scenarios, such as commodity trading and contract execution.

For example, in the case where user A exchanges the virtual data carrier A1 for user B's virtual data carrier B1, a specific implementation mode is as follows.

1. Firstly, the two users already know each other's users and digital identifiers of the two virtual data carriers.

User A adds an association initiation block x onto a blockchain of the virtual data carrier A1, expressing: exchange the virtual data carrier A1 for user B's virtual data carrier B1.

User B also adds an association initiation blocky to a blockchain of the virtual data carrier B1, expressing: exchange the virtual data carrier B1 for user A's virtual data carrier A1.

2. In the case where the association initiation block x and the association initiation block y are transmitted to the other through broadcast (in case of avoiding double spend, both parties have to wait for a certain time period after receiving the block).

User A adds an association completion block x2 behind the association initiation block y on the blockchain of the virtual data carrier B1, expressing: agree to exchange the virtual data carrier A1 for user B's virtual data carrier B1, see the association initiation block x (appended with complete data of the association initiation block x)”, and receives the virtual data carrier B1.

User B adds an association completion block y2 behind the association initiation block x on the blockchain of the virtual data carrier A1, expressing: “agree to exchange the virtual data carrier B1 for user A's virtual data carrier A1, see the association initiation block y (appended with complete data of the association initiation block y)”, and receives the virtual data carrier A1.

The associated transaction is completed.

If user A exchanges m virtual data carriers for n virtual data carriers of user B, user A only needs to change the virtual data carrier A1 above to virtual data carriers A11, . . . , A1m and change the virtual data carrier B1 to virtual data carriers B11, . . . , B1n; user A adds the association initiation block x respectively onto each virtual data carrier A1i, user B adds the association initiation block y respectively onto each virtual data carrier B1j, user A adds the association initiation block x2 respectively behind each association initiation block y, and user B adds the association initiation block y2 respectively behind each association initiation block x, to complete the associated transaction.

If user A cheats, user A does not broadcast the association initiation block x in the first step, and executes the second step as well after receiving the association initiation block y, because complete data of the association initiation block x is written in the association initiation block x2, as long as the association initiation block x2 is broadcast, the association initiation block x is also broadcast, and user B can receive the virtual data carrier A1 after all; if user A does not broadcast the association initiation block x2, then reception of the virtual data carrier B1 is not completed, and the virtual data carrier B1 cannot be spent thereafter.

If user B receives a block that conflicts with the association initiation block x during the waiting period after receiving the association initiation block x of user A (who conducts double spend), at this time, user A already adds the association completion block x2 to the virtual data carrier B1, then user B is authorized to add double-spend information behind the association initiation block x2, cancel the associated transaction, and take back ownership of the virtual data carrier B1.

The association initiation block has a valid period; if user A does not receive the association initiation block from user B until time expires so that association cannot be completed, then user A may add a proposed disassociation block to the virtual data carrier A1 and broadcast, and after waiting a time period, if there is no conflict block, add another block to disassociate. If user B already broadcast the association completion block during the waiting time period, other nodes will send the association completion block of user B to user A when discovering conflict, and user A may complete association.

More complex exchanges may involve a plurality of users and a plurality of virtual data carriers; similar to the above-described process, an owner of each virtual data carrier firstly adds and broadcasts an association initiation block to the end of the blockchain of the virtual data carrier, stating a complete exchange plan, then collects together association initiation blocks broadcast by other parties required to complete the plan, writes into an association completion block, and adds the association completion block to the end of the blockchain of each virtual data carrier to be obtained. In a multilateral transaction, any participant who discovers that someone conducts double spend before adding an association completion block is authorized to add double-spend information to a cancellation block and add the cancellation block to blockchains of all virtual data carriers to cancel the entire transaction.

With respect to exchanges involving only two participants, i.e., user A and user B, there may be another process; and an advantage of the process is that only user A, but not user B, needs to know IDs of the virtual data carrier A1 and the virtual data carrier B1 before starting:

1. User A adds an association initiation block x onto the virtual data carrier A1: exchange the virtual data carrier A1 for user B's virtual data carrier B1;

2. User B receives x, waits for a time period, and adds an association confirmation block y onto the virtual data carrier B1: refer to the association initiation block x, agree to exchange the virtual data carrier B1 for the virtual data carrier A1;

User B appends data of the association initiation block y onto the association initiation block x as an association completion block, and then receives the virtual data carrier A1;

3. User A receives the association initiation block y, waits for a time period, adds an association completion block behind the association initiation block y, and receives the virtual data carrier B1.

Such a mode may better solve a trust problem of a remote transaction than some payment software.

In order to introduce partial ownership to improve reliability of ownership transfer of a virtual data carrier, to further improve data processing security of the blockchain network, the present disclosure provides a data processing method embodiment in which an executive subject is any one node in a blockchain network; and referring to FIG. 14, the data processing method specifically comprises contents as follows.

Step 1401: receiving a block addition message which corresponds to a payment block with respect to the target virtual data carrier and is broadcast by any one node in the blockchain network.

Step 1402: judging whether an amount of owner user identifiers is more than one in the block addition message corresponding to the payment block of the target virtual data carrier; if so, determining, according to ownership contents of owner users corresponding to the respective owner user identifiers, whether the block addition message corresponding to the payment block is legitimate.

As discussed earlier, the virtual data carrier belongs to only one owner, and the owner completely owns the virtual data carrier. There is also a case where a virtual data carrier belongs to a plurality of owners, and each owner has partial ownership.

For example, an object of the virtual data carrier is a company, and owners include two shareholders, a shareholder A has 40% of the shares, and a shareholder B has 60% of the shares. On a blockchain of the virtual data carrier of the company, the shareholder A may transfer 40% of shares to a shareholder C, and the shareholder B may transfer 20% of shares to a shareholder D. At this time, a share structure is that: B has 40%, C has 40%, D has 20%, and A has none.

A key point of the operation is that, a transferor needs to prove to have enough shares to transfer out by the method of ensuring sequence of the transfer blocks to avoid forks (which may be expressed with a directed acyclic graph (DAG) with forks; however, such a structure has a large amount of data, rendering excessively low confirmation efficiency). If everyone can add blocks at any time, even if there is no malicious operation, forks may be caused. In order to avoid forks, everyone's addition authority must be confined by a consensus solution.

A simple solution is rotational allocation by time, one hour is given to a person. In a first hour, only the shareholder A is authorized to add a transfer block; whether the shareholder adds or not, it is the shareholder B's turn in a next hour, and then it is the shareholder C's turn in a next hour, . . . , thereby, ensuring that transfer blocks added by everyone are all on a same blockchain.

Such a mode may operate well in the case of a small amount of shareholders. In the case where shareholders are too many, the rotation cycle is too long to be practical; at this time, the virtual data carrier should be split into a plurality of virtual data carriers according to owners, and each new virtual data carrier belongs to only one owner. A splitting method is similar to freezing a virtual data carrier to issue secondary virtual data carriers as described in step 1901 to step 1903.

With the assumption that an arbitrarily long rotation cycle can be tolerated, the method may grow into another decentralized, secure and power-saving cryptocurrency solution—as long as the object of the virtual data carrier is the total amount of cryptocurrency.

In an embodiment of the present disclosure, it is necessary to charge a user fees for each addition block, otherwise, the blockchain may be vulnerable to an infinite transfer attack—an attacker continuously transfers a virtual data carrier, thereby enabling the blockchain too long to operate.

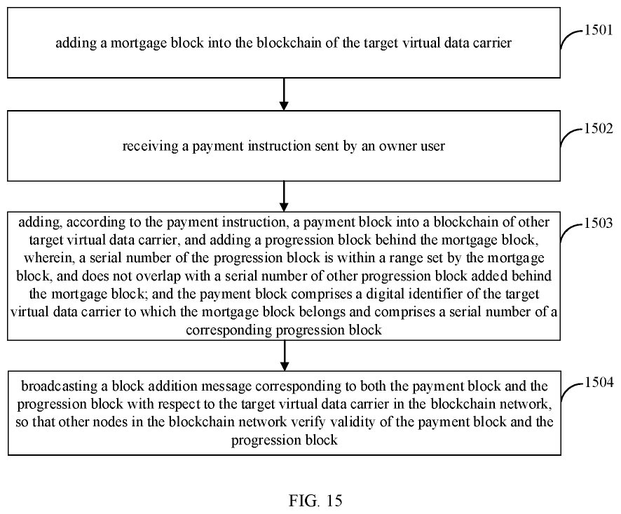

In order to improve mortgage reliability of the virtual data carrier and further improve data processing security of the blockchain network, the present disclosure provides a data processing method embodiment in which an executive subject is any one node in a blockchain network; and referring to FIG. 15, the data processing method specifically comprises contents as follows.

Step 1501: adding a mortgage block into the blockchain of the target virtual data carrier.

Step 1502: receiving a payment instruction sent by an owner user.

Step 1503: adding, according to the payment instruction, a payment block into a blockchain of other target virtual data carrier, and adding a progression block behind the mortgage block, wherein, a serial number of the progression block is within a range set by the mortgage block, and does not overlap with a serial number of other progression block added behind the mortgage block; and the payment block comprises a digital identifier of the target virtual data carrier to which the mortgage block belongs and comprises a serial number of a corresponding progression block.

Step 1504: broadcasting a block addition message corresponding to both the payment block and the progression block with respect to the target virtual data carrier in the blockchain network, so that other nodes in the blockchain network verify validity of the payment block and the progression block.

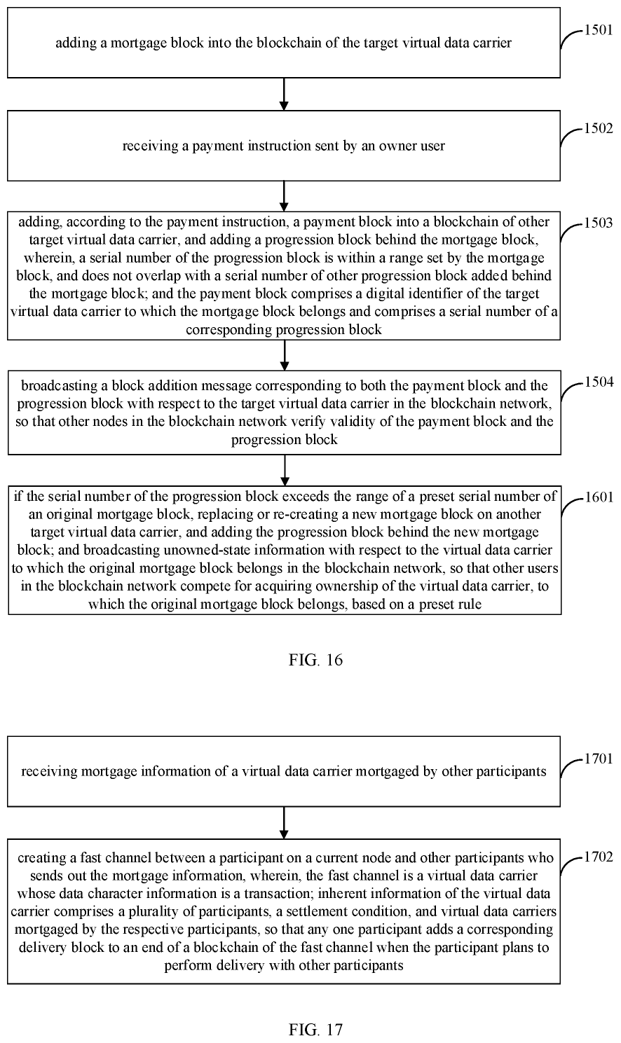

In a specific embodiment, referring to FIG. 16, the data processing method specifically comprises the following contents.

Step 1601: if the serial number of the progression block exceeds the range of a preset serial number of an original mortgage block, replacing or re-creating a new mortgage block on another target virtual data carrier, and adding the progression block behind the new mortgage block; and broadcasting unowned-state information with respect to the virtual data carrier to which the original mortgage block belongs in the blockchain network, so that other users in the blockchain network compete for acquiring ownership of the virtual data carrier, to which the original mortgage block belongs, based on a preset rule.

Specifically: charging should also be decentralized. For example, 0.01 yuan must be paid every time a payment block is added, then a user needs to add a mortgage block to a virtual data carrier in a case where the owner user is himself/herself; it is assumed that user A mortgages a virtual data carrier N with a face value of one yuan, then the virtual data carrier may supply fees for 100 payments, each time with a serial number, 1 to 100.

Every time adding a payment block, user A should state a digital identifier of the virtual data carrier N and a serial number of the present payment, and add a block with a progression serial number behind the mortgage block of the virtual data carrier N (all progression blocks may be directly added in parallel behind the mortgage block, or may also be added behind a previous progression block), add a block with a progression serial number on the blockchain of the virtual data carrier N, and broadcast the progression block together with the payment block; and other nodes approve the payment only when verifying both of the progression block and the payment block to be valid. Double spend is also prohibited for the progression block, and a serial number of each progression block is different from serial numbers of other progression blocks with respect to a same mortgage block. If a user is required to pay in series, a minimum release time interval of two progression blocks with different serial numbers may be limited, to prohibit a user from simultaneously paying a plurality of virtual data carriers. Till the serial number reaches 100, the virtual data carrier N is used up, user A should mortgage another virtual data carrier to support subsequent payments, and the virtual data carrier N enters an unowned state.

When learning that the virtual data carrier N has entered an unowned state, other nodes may compete for ownership of the virtual data carrier N according to certain rules, and the winner may obtain the virtual data carrier N. The rules may be set as below.

Among all successfully-paid payment blocks of the virtual data carrier on a previous day (0:00 to 24:00) before the virtual data carrier N enters the unowned state, a receiver, whose ID is the closest to the ID of the last progression block of the virtual data carrier N, is selected. The receiver adds a reception block to the virtual data carrier N and writes in data of the payment block selected above, so as to be capable to receive the virtual data carrier N.

As described above, the progression block may be directly added behind the mortgage block in parallel, so that after the unowned virtual data carrier N is received by other person, other progression blocks except the last progression block no long need to be recorded, which may reduce a length of the blockchain.

In order to compete for the unowned virtual data carrier, the respective users may have to register a plurality of accounts; however, in addition to costs of registering the accounts, the accounts are required to gain incomes every day, so as to be qualified as a candidate; and this way increases a lot of unnecessary transfers and fees, thereby resulting in more loss than gains.

With respect to an infinite-transfer attacker, although the infinite-transfer attacker may obtain some unowned virtual data carriers, yet because it is the ID of the receiver's account, rather than the ID of the payment block, that is used for competing for the unowned virtual data carrier. Transfer money back and forth in only a few accounts, so that competing for the unowned virtual data carrier is neither efficient, nor can offset costs of a plurality of payments.

With respect to operations other than payment, for example, condition operation, freezing the virtual data carrier to issue secondary virtual data carriers, adding free information into blocks, etc., fees may be charged according to different standards.

In addition, based on the above-described contents, in order to further improve data processing efficiency of the blockchain network, in the data processing method embodiment of the present disclosure, referring to FIG. 17, the data processing method specifically comprises contents as below.

Step 1701: receiving mortgage information of a virtual data carrier mortgaged by other participants.

Step 1702: creating a fast channel between a participant on a current node and other participants who sends out the mortgage information, wherein, the fast channel is a virtual data carrier whose data character information is a transaction; inherent information of the virtual data carrier comprises a plurality of participants, a settlement condition, and virtual data carriers mortgaged by the respective participants, so that any one participant adds a corresponding delivery block to an end of a blockchain of the fast channel when the participant plans to perform delivery with other participants.

Specifically, if a plurality of users have demands of a plurality of mutual deliveries, a fast channel may be established for them to improve efficiency and avoid broadcasting and waiting for each delivery.

Before establishing the fast channel, all the participants (users) should mortgage several virtual data carriers in a case where the owner user is himself/herself respectively, that is, add mortgage blocks to ends of blockchains corresponding to these virtual data carriers; virtual data carriers mortgaged by different participants may be objects of different types and with different quantities; and a plurality of virtual data carriers mortgaged by a same participant may also be objects of different types and with different quantities.

After the mortgaged virtual data carrier is determined, a participant creates a fast channel; the fast channel is a transaction type of virtual data carrier, and has participant, settlement conditions and a virtual data carrier mortgaged by each participant stated in inherent information of the fast channel. The settlement conditions may be settlement according to time or according to requirements of the participants. After the creation, other participants should add blocks onto the end of the blockchain of the fast channel, expressing their consent to participate.

After the fast channel is established, if any participant delivers an object indicated by the virtual data carrier to other participants, the participant may not transfer the virtual data carrier, but add a block onto the end of the blockchain of the fast channel, stating that a certain amount of object should be delivered to a certain participant. The respective participants should ensure no fork of the blockchain of the fast channel, and a total amount payable and receivable by each participant for each type of object can be clearly calculated at any time. A net payable amount by each participant for any type of object should not exceed the amount of a same type of object mortgaged by the participant himself/herself when the fast channel is created.

Settlement begins after the settlement conditions are met; with respect to each type of object involved, a participant of a net receivable account may withdraw the mortgaged virtual data carrier; as for a participant of a net payable account, two operations, i.e., withdrawing the mortgaged virtual data carrier and settling the account are associated, the virtual data carrier must be settled before the mortgaged virtual data carrier can be withdrawn; if the account is not settled after a time period, the participant of the net receivable account may enforce mandatory settlement, deducting a payable portion from the virtual data carrier mortgaged by the participant of the net payable account and giving the virtual data carrier deducting the payable portion to the participant of the net receivable account. The foregoing “deducting” operation may be implemented in two ways: 1. the participant of the net receivable account (associating operation) makes change; and 2. the mortgaged virtual data carrier is frozen to create secondary virtual data carriers of a smaller face value to pay the participant of the net receivable.

When user A and user B, and user B and user C respectively establish fast channels, then user A and user C may connect the two fast channels in series to form a multi-stage fast channel, which, in this way, may be gradually connected farther and farther, so delivery may be quickly carried out afar. Each delivery in the multi-stage fast channel is essentially an associating operation of putting together deliveries of each section of channel in the multi-stage fast channel.

It can be understood that, the blockchains are divided into public blockchains and private blockchains. A public blockchain refers to a blockchain, that everyone is authorized to add blocks technically, and requires a consensus algorithm to determine legitimacy of a block added. A private blockchain is a blockchain that only the owner of the private blockchain is authorized to add blocks, but allows others only to read.

In terms of payment block, the blockchain corresponding to the virtual data carrier in the present disclosure is essentially the private blockchain, and only by an owner of the blockchain is authorized to add blocks. But unlike a general private blockchain, the owner can transfer the ownership of the blockchain to a designated person by adding a block, thereby changing the owner of the blockchain, and thereafter, only the new owner is authorized to add a payment block.

In addition, in order to implement other functions, various blocks may be added onto the blockchain of the virtual data carrier; each type of block has a different restriction on the adder; the payment block can only be added by a current owner, and other blocks may also be added by a person designated by the owner, other specific person or everyone. In this way, blockchains of virtual data carriers vary in public-private attribute with a type of block, and thus, may also be regarded as a public-private hybrid blockchain.

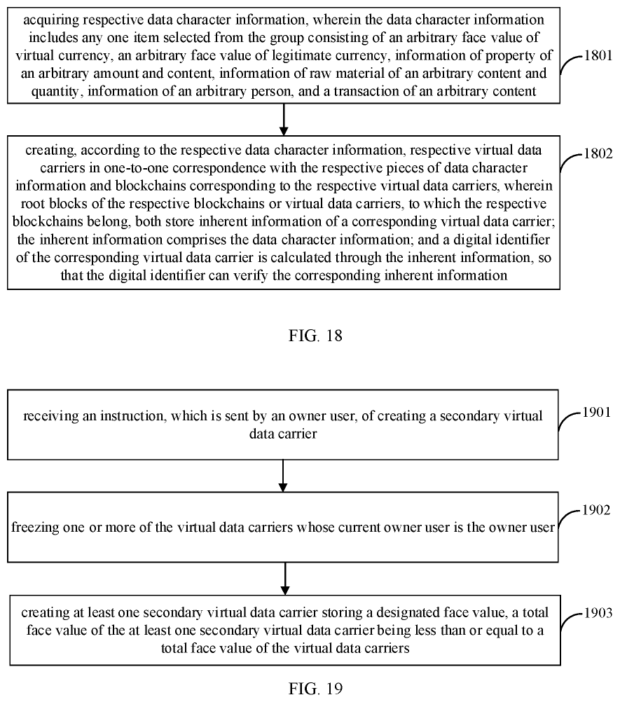

In order to improve efficiency and reliability of creating the virtual data carrier, to further improve data processing security of the blockchain network, the present disclosure provides a data processing method embodiment in which an executive subject is any one node in a blockchain network; and referring to FIG. 18, the data processing method specifically comprises contents as below.

Step 1801: acquiring respective data character information, wherein the data character information includes any one item selected from the group consisting of an arbitrary face value of virtual currency, an arbitrary face value of legitimate currency, information of property of an arbitrary amount and content, information of raw material of an arbitrary content and quantity, information of an arbitrary person, and a transaction of an arbitrary content.

Step 1802: creating, according to the respective data character information, respective virtual data carriers in one-to-one correspondence with the respective pieces of data character information and blockchains corresponding to the respective virtual data carriers, wherein root blocks of the respective blockchains or virtual data carriers, to which the respective blockchains belong, both store inherent information of a corresponding virtual data carrier; the inherent information comprises the data character information; and a digital identifier of the corresponding virtual data carrier is calculated through the inherent information, so that the digital identifier can verify the corresponding inherent information.

It can be understood that, a specific mode of creating, according to the respective data character information, respective virtual data carriers in one-to-one correspondence with the respective data character information and blockchains corresponding to the respective virtual data carriers may include four types as below.

1. Virtual data carriers are created in a batch in an initial period and no longer created thereafter.

2. Virtual data carriers are created in a batch in the initial period, and then automatically created and distributed according to a preset procedure.

3. A virtual data carrier is created by any one user through proof of work, and a face value of the virtual data carrier reflects an amount of work.

4. A virtual data carrier is created from other form of wealth transferred in by any one user.

Specific instructions are as follows.

1. Virtual data carriers are created in a batch in the initial period and no longer created thereafter. Each node remembers digital identifiers of those initially-created virtual data carriers, and only believes these virtual data carriers valid; even if a new virtual data carrier is created by someone, the digital identifier of the new virtual data carrier must be different from the others and will not be accepted by other nodes. Advantages of the mode are intactness of the three objectives, i.e., decentralization, security, and low power consumption, and ease of implementation; and a disadvantage is obvious deflation expectations to be brought about.

2. A plurality of virtual data carriers are created in a batch in the initial period, and then automatically created and distributed according to a preset procedure. An operating effect of the plurality of virtual data carriers depends on a design level of the preset procedure. If the preset procedure maintains unchanged, a loophole is easily found by an attacker; and if the preset procedure is changeable, an updater of the procedure will become a key person, thereby affecting the requirement of decentralization.

3. The virtual data carrier is created by any one user through proof of work, and a face value of the virtual data carrier reflects an amount of work. A disadvantage is more power consumption; and an advantage is that the quantity of creating the cryptocurrency may be flexibly adapted to market needs, which is favorable for currency stability. It should be noted that, electricity is wasted in the process of creating the virtual data carrier, but not a payment process; payment may still be made without creating a new currency, which is different from the case of Bitcoin, where a lot of electricity are wasted for account-keeping every time.

4. The virtual data carrier is created from other form of wealth transferred in by any one user. An advantage of the solution is ease of connection with the existing economic system; and a disadvantage is need of a central institution to do exchange work, which is suitable for occasions that do not require decentralization.

In a specific implementation mode, if the data character information is a transaction, the data processing method specifically comprises contents as below: creating a virtual data carrier storing a procedure or a rule of the transaction in inherent information. All participants of the transaction shall execute the transaction according to the procedure or the rule; the procedure or the rule includes adding, by a participant, a change block to a blockchain corresponding to the virtual data carrier in a mode prescribed by the procedure or the rule, to modify contents of the procedure or the rule.

The blockchain corresponding to the virtual data carrier has characteristics as below.

1. On different blockchains, with respect to each type of block, different users may have different adding permissions;

2. The above-described permissions of different users may be changed by adding blocks;

3. The above-described permission modification rule may be a global rule, or may also be stipulated in the inherent information of the virtual data carrier, or may also be modified by adding blocks.

In order to further improve data processing security of the blockchain network by introducing a concept of secondary virtual data carrier, the present disclosure provides a data processing method embodiment in which an executive subject is any one node in the blockchain network; referring to FIG. 19, if data character information is an arbitrary face value of virtual currency or legitimate currency, the data processing method specifically comprises contents as below.

Step 1901: receiving an instruction, which is sent by an owner user, of creating a secondary virtual data carrier.

Step 1902: freezing one or more of the virtual data carriers whose current owner user is the owner user.

Step 1903: creating at least one secondary virtual data carrier storing a designated face value, a total face value of the at least one secondary virtual data carrier being less than or equal to a total face value of the virtual data carriers.

Specific instructions are as follows.

1. If a virtual data carrier of a specific face value is needed, one or more virtual data carriers may be frozen as a creation basis; and several virtual data carriers of a designated face value are created, which are referred to as the secondary virtual data carriers. During circulation of the secondary virtual data carriers, the virtual data carrier used as the creation basis is in a frozen state and cannot be circulated; and it is not until the user recovers all the secondary virtual data carriers and destroys them, that the creation basis may be unfrozen.

A new face value is created after freezing: user A wants to give his/her lover a virtual data carrier with a face value of 521 yuan, user A freezes three virtual data carriers with a face value of 200 yuan which are used as a creation basis, thereby, creating a virtual data carrier of 521 yuan.

2. The secondary virtual data carriers may be issued additionally: during the freezing period, a user may destroy part of the secondary virtual data carriers created by himself/herself, or may also additionally issue new secondary virtual data carriers under the premise that a total face value of all the secondary virtual data carriers does not exceed the creation basis. Freezing, unfreezing, issuing and destroying operations are also executed by a way of adding blocks to the end of the blockchain of the virtual data carrier.

Based on the above-described creation basis, user A may further create a virtual data carrier with a total face value of 79 yuan; user A may create one piece or a plurality of pieces virtual data carriers, and may create in one time or a plurality of times.

This method may also be used for describing a production process of a commodity: freezing a raw material and producing a product. In this way, the raw material of the product may be traced to avoid fraud.

In another embodiment of the secondary virtual data carrier, if the data character information is information of raw materials or components of the arbitrary content and quantity, the data processing method further comprises:

(1) Freezing a virtual data carrier whose data character information is the information of raw materials or components of the arbitrary content and quantity;

(2) Creating at least one secondary virtual data carrier storing a designated product, a sum of required raw materials or components required for a product of the secondary virtual data carrier being less than or equal to a sum of raw materials or components indicated by the data character information of the virtual data carrier.

In other words, freezing the virtual data carrier to issue secondary virtual data carriers may be used for describing the production process of the commodity: freezing the raw material and producing the product. In this way, the raw material of the product may be traced to avoid fraud. In the blockchain corresponding to the virtual data carrier whose object is a commodity, a change history of ownership of the commodity is clearly recorded, indicating at any time legitimate owners of respective time periods, and preventing illegitimate possession. The recording mode may prevent most property crimes, such as theft, robbery, embezzlement, money laundering, and fraud.

In addition, in an embodiment of the present disclosure, if the initial setting of the cryptocurrency allows a user to create the virtual data carrier through proof of work, conditions are that: the first 10 bits (binary) of the digital identifier of the generated virtual data carrier are all 0, then the face value of the virtual data carrier may be 1 yuan; the first 13 bits are all 0, then the face value may be 8 yuan. Users may continue to add redundant data into the inherent information and calculate the digital identifier until the conditions are met. When the price of electricity consumed for creating the virtual data carrier is less than the face value of the generated virtual data carrier, someone will create a new virtual data carrier, thereby preventing a currency value of the virtual data carrier from being too high.

In an embodiment of the present disclosure, practical currency should be able to be issued additionally to avoid deflation. A decentralized additional issuance method is as follows.

With respect to the unowned virtual data carrier as discussed in step 1601, if the ID of the last progression block conforms to a specific format, a user who finally wins the unowned virtual data carrier is authorized to create a new virtual data carrier with a designated face value. The specific format of the ID of the progression block may have a plurality of standards with different degrees of difficulties, thereby corresponding to create virtual data carriers with different face values.

Although by using the above-described method, virtual data carriers may be issued additionally, yet an additional issuance rate is directly proportional to an average transfer rate of the virtual data carriers (the transfer results in unowned virtual data carriers), which will aggravate inflation or deflation. To stabilize a currency value, it is necessary to calculate a usage rate (a total circulation amount/a total payment number of the virtual data carriers) of the virtual data carriers with different face values in the past time period, based on which reverse regulation is performed on a face value coefficient for creating the virtual data carriers. For example, in the past time period, an average face value of virtual data carriers in circulation is too large, thereby indicating inflation underway, and the face value coefficient for creating the virtual data carriers should be lowered, and vice versa.

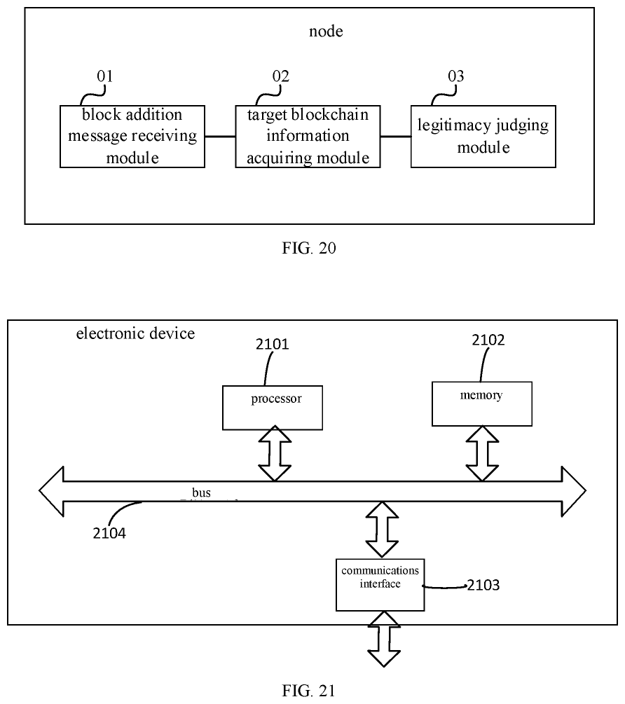

In order to simplify data processing of the blockchain network and improve efficiency of legitimacy judgment in data transmitting, to effectively improve data processing efficiency of the blockchain network while ensuring decentralization and security of the blockchain network, and effectively lower power consumption for data processing, the present disclosure further provides an embodiment of a node for implementing all or an arbitrary content in the above-described data processing method; and referring to FIG. 20, the node specifically comprises contents as below.

A block addition message receiving module 01 is configure to receive a block addition message which is with respect to a target virtual data carrier and sent by any one node in the blockchain network. the block addition message comprises a digital identifier corresponding to the target virtual data carrier, data change information, and an owner user identifier, the blockchain network comprises a plurality of virtual data carriers storing data character information, and each virtual data carrier is provided with a unique corresponding digital identifier corresponds to at least one blockchain.

A target blockchain information acquiring module 02 is configured to acquire target blockchain information corresponding to the target virtual data carrier, according to the digital identifier corresponding to the target virtual data carrier.

A legitimacy judging module 03 is configured to judge, based on data change history information, which is in the target blockchain information, of at least one block, whether the data change information in the block addition message is legitimate, and if legitimate, confirm the data change information in the block addition message.

It can be seen from the above-described content that, the node provided by the embodiment of the present disclosure, by setting each virtual data carrier to correspond to one blockchain, so that respective nodes only need to voluntarily verify legitimacy of the node without reaching a consensus with other respective nodes through the competition and consensus mechanism, such as proof of work, and broadcast after verification, can effectively improve the data processing efficiency of the blockchain network while ensuring the decentralization and security of the blockchain network, and can effectively lower power consumption for data processing.

In order to improve efficiency of legitimacy judgment in data transmitting, to further effectively improve data processing efficiency of the blockchain network while ensuring decentralization and security of the blockchain network, and effectively lower power consumption for data processing, the present disclosure further provides an embodiment of a blockchain network comprising the above-described plurality of nodes for implementing all or an arbitrary content in the above-described data processing method. The blockchain network, by setting each virtual data carrier to correspond to one blockchain, so that respective nodes only need to voluntarily verify the legitimacy of the node without reaching a consensus with other respective nodes through the competition and consensus mechanism, such as proof of work, and broadcast after verification, can effectively improve the data processing efficiency of the blockchain network while ensuring the decentralization and security of the blockchain network, and can effectively lower power consumption for data processing.

In order to improve efficiency of legitimacy judgment in data transmitting, to further effectively improve the data processing efficiency of the blockchain network while ensuring the decentralization and security of the blockchain network, and effectively lower power consumption for data processing, the present disclosure further provides an embodiment of a virtual data carrier. The virtual data carrier is used for storing data character information and provided with a unique digital identifier, each virtual data carrier corresponds to at least one blockchain; the respective blockchains all belong to the foregoing blockchain network, and the blockchain network comprises the above-described plurality of nodes for implementing all or an arbitrary content in the above-described data processing method.

If the virtual data carrier is used to represent the cryptocurrency, it specifically comprises contents as below.

(1) The virtual data carrier is taken as a carrier for payment in the cryptocurrency; each virtual data carrier has a face value, and represents a designated amount of cryptocurrency; each virtual data carrier has a blockchain, which may be used to record a transfer history of the ownership of the virtual data carrier.

(2) Each virtual data carrier has a unique and eternal digital identifier, which is used to distinguish different virtual data carriers and to verify the inherent information of the virtual data carrier; the inherent information comprises the face value of the virtual data carrier, and may also contain contents, such as creation time, creator, and creation basis of the virtual data carrier.

(3) The record in the blockchain of each virtual data carrier indicates a current owner of the virtual data carrier; the current owner is authorized to add a block onto an end of the blockchain of the virtual data carrier thereby transferring the ownership of the virtual data carrier to another; every payment in the cryptocurrency is reflected in the transfer of the ownership of several virtual data carriers, which is dispersedly recorded on respective blockchains of these virtual data carriers.

(4) There are several solutions for creating virtual data carriers. Solution one is that virtual data carriers are created in a batch in an initial period and no longer created thereafter; solution two is that virtual data carriers are created in a batch in the initial period, and then automatically created and distributed according to a preset procedure; solution three is that a virtual data carrier is created by any one user through proof of work; and solution four is that a virtual data carrier is created from other form of wealth transferred in by any one user.

(5) The user may freeze one or more virtual data carriers, and the virtual data carriers are used as a creation basis to voluntarily create several secondary virtual data carriers; and the frozen virtual data carrier cannot be circulated, and can be unfrozen only when the user recovers and destroys all the secondary virtual data carriers created with the virtual data carrier as the creation basis.

(6) Payment may have execution conditions.

(7) A plurality of payments may be associated together; the associated payments have to be simultaneous completed or cancelled; and a situation that some are completed and the others cancelled is not allowed.

Based on the above-described content, the present disclosure introduces a concept of the virtual data carrier to the cryptocurrency, which turns the cryptocurrency from a number into an atomic object, which is close to a concept of “this currency, that currency”. In the original cryptocurrencies such as Bitcoin, if user u1 says to give user u2 money with a face value of 10 yuan, user u1 must prove that an account of user u1 originally has no less than 10 yuan (a number), which involves a lot of consensus calculations, resulting in waste of electricity. However, in the present disclosure, as long as the user is given a virtual data carrier, the virtual data carrier (an object) is there and visible to everyone; the virtual data carrier must belong to a certain user before the user is authorized to add the payment block, which cannot be added by anyone else, so consensus algorithm and power consumption are not needed.

It can be seen from the above description that, with respect to the virtual data carrier provided by the embodiment of the present disclosure, a blockchain of each virtual data carrier records all its own payments; records of all the virtual data carriers constitute all payment records of the cryptocurrency with the virtual data carrier as a carrier; and a unique centralized blockchain like the existing cryptocurrency is no longer needed, which implements complete decentralization. With respect to the blockchain of each virtual data carrier, only one user is authorized to add each new block in each state, without competition. In addition, each block only involves payment of one virtual data carrier, and is unrelated with accounts of others, so there is no need to seek consensus with others. Therefore, the circulation process of cryptocurrency based on the virtual data carrier does not require a mechanism, such as proof of work, so that mutual payment may be quickly carried out while saving electricity. On the other hand, these changes will not compromise security provided by the blockchain itself. Therefore, cryptocurrency based on the virtual data carrier achieve the three objectives, i.e., decentralization, security, and low power consumption at a same time, thereby enabling the cryptocurrency truly hopeful to become the cornerstone of the social economy.

An embodiment of the present disclosure further provides a specific implementation mode of an electronic device that can implement all the steps in the data processing method according to the above-described embodiment; and referring to FIG. 21, the electronic device specifically comprises a processor 2101, a memory 2102, a communications interface 2103, and a bus 2104.

The processor 2101, the memory 2102, and the communications interface 2103 communicate with each other through the bus 2104; the communications interface 2103 is used for information transmission between related devices or platforms, such as a node represented by itself, other nodes in the blockchain network, and other blockchain networks.

The processor 2101 is configured to call a computer program in the memory 2102; the processor implements all or part of the steps in the data processing method according to the above-described embodiment when executing the computer program; for example, the processor, when executing the computer program, implements the following steps.

Step 11: receiving a block addition message which is with respect to a target virtual data carrier and sent by any one node in the blockchain network, the block addition message comprising a digital identifier corresponding to the target virtual data carrier, data change information, and an owner user identifier, wherein the blockchain network comprises a plurality of virtual data carriers storing data character information and each provided with a unique corresponding digital identifier, and each of the virtual data carriers corresponds to at least one blockchain.

Step 12: acquiring target blockchain information corresponding to the target virtual data carrier, according to the digital identifier corresponding to the target virtual data carrier.

Step 13: judging, based on data change history information, which is in the target blockchain information, of at least one block, whether the data change information in the block addition message is legitimate, and if legitimate, confirming the data change information in the block addition message.

It can be seen from the above-described contents that, the electronic device provided by the embodiment of the present disclosure, by setting each virtual data carrier to correspond to at least one blockchain, so that respective nodes only need to voluntarily verify the legitimacy of the node without reaching a consensus with other respective nodes through the competition and consensus mechanism, such as proof of work, and broadcast after verification, can effectively improve the data processing efficiency of the blockchain network while ensuring the decentralization and security of the blockchain network, and effectively lower power consumption for data processing.

An embodiment of the present disclosure further provides a computer-readable storage medium that can implement all the steps in the data processing method according to the above-described embodiment; the computer-readable storage medium store a computer program, the computer program, when executed by a processor, implements all or part of the steps of the data processing method according to the above-described embodiment; for example, the processor, when executing the computer program, implements the following steps.

Step 11: receiving a block addition message which is with respect to a target virtual data carrier and sent by any one node in the blockchain network, the block addition message comprising a digital identifier corresponding to the target virtual data carrier, data change information, and an owner user identifier, wherein the blockchain network comprises a plurality of virtual data carriers storing data character information, and each virtual data carrier is provided with a unique corresponding digital identifier and corresponds to at least one blockchain.

Step 12: acquiring target blockchain information corresponding to the target virtual data carrier, according to the digital identifier corresponding to the target virtual data carrier.

Step 13: judging, based on data change history information, which is in the target blockchain information, of at least one block, whether the data change information in the block addition message is legitimate, and if legitimate, confirming the data change information in the block addition message.

It can be seen from the above-described contents that, the computer-readable storage medium provided by the embodiment of the present disclosure, by setting each virtual data carrier to correspond to at least one blockchain, so that respective nodes only need to voluntarily verify the legitimacy of the node without reaching a consensus with other respective nodes through the competition and consensus mechanism, such as proof of work, and broadcast after verification, can effectively improve the data processing efficiency of the blockchain network while ensuring the decentralization and security of the blockchain network, and effectively lower power consumption for data processing.

Respective embodiments in the present disclosure are described in a progressive manner, same or similar parts among the respective embodiments may be referred to each other; each embodiment focuses on difference from other embodiments. In particular, with respect to the embodiment of the hardware and program, because it is basically similar to the method embodiment, description thereof is relatively simple, and for the related parts, description of the parts of the method embodiment may be referred to.

Specific embodiments of the subject described herein were described. Other embodiments may be included in the scope of the appended claims. For example, even when operations claimed in the claims are performed in an order different from that in the embodiment, a desirable result may still be achieved. In addition, a procedure shown in the accompanying drawings may not necessarily require a specific shown order or a sequential order in order to obtain the desirable result. In some implementation modes, multitasking and parallel processing may also be possible or preferable.

Although the present disclosure provides methodical operation steps as described in the embodiments or flow charts, more or fewer operation steps may be included in the method based on the conventional labor or a non-inventive labor. The sequence of steps listed in the embodiments is only one way of numerous step execution orders, and does not represent the only execution order. When executed by an actual apparatus or client product, the steps may be executed in series or in parallel according to the methods shown in the embodiments or the accompanying drawings (e.g., a parallel processor or a multi-threaded processing environment).

The system, apparatus, module, or unit illustrated in the above-described embodiments may be specifically implemented by using a computer chip or an entity, or may be implemented by using a product having a certain function. A typical implementing device is a computer. Specifically, the computer may be, for example, a personal computer, a laptop computer, a vehicle-mounted human-computer interaction device, a cellular phone, a camera phone, a smartphone, a personal digital assistant, a media player, a navigation device, an email device, a game console, a tablet computer, a wearable device, or a combination of any of these devices.

Although the embodiments of the present disclosure provides methodical operation steps as described in the embodiments or flow charts, more or fewer operation steps may be included in the method based on the conventional labor or a non-inventive means. The sequence of steps listed in the embodiments is only one way of the execution order of the steps, and does not represent the only execution order. When executed by an actual apparatus or terminal product, the steps may be executed sequentially or in parallel according to the methods shown in the embodiments or drawings (e.g., in a parallel processor or multi-threaded processing environment, or even a distributed data processing environment). The terms “include”, “comprise”, or their any other variants are intended to cover a non-exclusive inclusion, so that a process, a method, a product or a device that includes a list of elements not only includes those elements but also includes other elements that are not expressly listed, or further includes elements inherent to such process, method, product or device. Without more constraints, it does not exclude that there is another same or identical element in the process, method, product, or device that includes the element.

For ease of description, the apparatus above is described by dividing functions into various modules. Certainly, when the embodiments of the present disclosure is implemented, functions of respective modules may be implemented in one or more pieces of software and/or hardware, or modules that implement a same function may be implemented by a combination of a plurality of sub-modules or sub-units. The apparatus embodiment as described above is merely exemplary. For example, the unit division is merely logical function division and there may be other division mode in actual implementation; for example, a plurality of units or components may be combined or integrated into another system, or some features may be ignored or not executed. One more point is that, mutual coupling or direct coupling or communicative connection as displayed or discussed may be an indirect coupling or communicative connection through some interfaces, apparatuses or units, and it may be electrical, mechanical or in other form.

Those skilled in the art also know that, in addition to implementing the controller by using the computer readable program code, logic programming can be performed on method steps to allow the controller to implement the same function in forms of the logic gate, the switch, the application-specific integrated circuit, the programmable logic controller, and the built-in microcontroller. Therefore, the controller may be considered as a hardware component, and an apparatus included in the controller and configured to implement various functions may also be considered as a structure in the hardware component. Or the apparatus configured to implement various functions may even be considered as both a software module implementing the method and a structure in the hardware component.

The present disclosure is described with reference to the flow charts and/or block diagrams of the method, the device (system), and the computer program product based on the embodiments of the present disclosure. It should be understood that computer program instructions may be used to implement each process and/or each block in the flow charts and/or the block diagrams and a combination of a process and/or a block in the flow charts and/or the block diagrams. These computer program instructions may be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more processes in the flow charts and/or in one or more blocks in the block diagrams.

These computer program instructions may also be stored in a computer readable memory that can instruct the computer or other programmable data processing device to work in a specific way, so that the instructions stored in the computer readable memory generate an artifact that includes an instruction apparatus. The instruction apparatus implements a specific function in one or more processes in the flow charts and/or in one or more blocks in the block diagrams.

These computer program instructions may also be loaded onto the computer or other programmable data processing device, so that a series of operations and steps are executed on the computer or other programmable device, thereby generating computer-implemented processing. Therefore, the instructions executed on the computer or other programmable device provide steps for implementing a specific function in one or more processes in the flow charts and/or in one or more blocks in the block diagrams.

In a typical configuration, a computing device includes one or more processors (CPU), one or more input/output interfaces, one or more network interfaces, and one or more memories.

The memory may include a non-persistent memory, a Random Access Memory (RAM), a nonvolatile memory, and/or other form that are in a computer readable medium, for example, a Read-Only Memory (ROM) or a flash memory (flash RAM). The memory is an example of the computer readable medium.

The computer readable medium includes persistent, non-persistent, removable, and irremovable media that can store information by using any method or technology. The information may be a computer readable instruction, a data structure, a program module, or other data. Examples of the computer storage medium include but are not limited to a Parameter Random Access Memory (PRAM), a Static Random Access Memory (SRAM), a Dynamic Random Access Memory (DRAM), other type of Random Access Memory (RAM), a Read-Only Memory (ROM), an Electrically Erasable Programmable Read-Only Memory (EEPROM), a flash memory or other memory technology, a Compact Disc Read-Only Memory (CD-ROM), a Digital Versatile Disc (DVD) or other optical storage, a cassette magnetic tape, a magnetic tape/magnetic disk storage, other magnetic storage device, or any other non-transmission medium, which may be configured to store information accessible by a computing device. As described in the present disclosure, the computer readable medium does not include computer-readable transitory media such as a modulated data signal and a carrier.

Those skilled in the art should understand that an embodiment of the present disclosure may be provided as a method, a system, or a computer program product. Therefore, the embodiments of the present disclosure may use a form of hardware only embodiments, software only embodiments, or embodiments with a combination of software and hardware. In addition, the embodiments of the present disclosure may use a form of a computer program product that is implemented on one or more computer-usable storage media (including but not limited to a disk memory, a CD-ROM, an optical memory, etc.) that include computer-usable program code.

The embodiments of the present disclosure may be described in the general context of computer executable instructions executed by a computer, for example, a program module. Generally, the program module includes a routine, a program, an object, a component, a data structure, etc. executing a specific task or implementing a specific abstract data type. The embodiments of the present disclosure may also be practiced in distributed computing environments. In the distributed computing environments, tasks are performed by remote processing devices connected through a communications network. In the distributed computing environment, the program module may be located in both local and remote computer storage media including storage devices.

Respective embodiments in the present disclosure are described in a progressive manner, same or similar parts among the respective embodiments may be referred to each other; each embodiment focuses on difference from other embodiments. In particular, with respect to the system embodiment, because it is basically similar to the method embodiment, description thereof is relatively simple, and for the related parts, description of the parts of the method embodiment may be referred to. In the description of the present disclosure, descriptions with reference to the terms “one embodiment”, “some embodiments”, “examples”, “specific examples”, or “some examples”, etc. mean that specific features, structures, materials or characteristics described in conjunction with the embodiment or example, are included in at least one embodiment or example of the embodiments of the present disclosure. In the present disclosure, the schematic representations of the above-described terms do not necessarily refer to the same embodiment or example. Moreover, the described specific features, structures, materials or characteristics may be combined in any one or more embodiments or examples in a suitable manner. In addition, those skilled in the art may combine or compose different embodiments or examples and features of different embodiments or examples described in the present disclosure without contradicting each other.

The previous descriptions are only embodiments the present disclosure, and are not intended to limit the embodiments the present disclosure. Those skilled in the art may make various modifications and changes to the present disclosure. Any modification, equivalent replacement, or improvement made without departing from the spirit and principle of the embodiments the present disclosure shall fall within the scope of the claims in the present disclosure.

1. A data processing method, comprising:
receiving a block addition message which is with respect to a target virtual data carrier and sent by any one node in a blockchain network, the block addition message comprising a digital identifier corresponding to the target virtual data carrier, and data change information, wherein the blockchain network comprises a plurality of virtual data carriers storing data character information, and each virtual data carrier is provided with a unique corresponding digital identifier and corresponds to at least one blockchain;
acquiring target blockchain information corresponding to the target virtual data carrier, according to the digital identifier corresponding to the target virtual data carrier; and
judging, based on data change history information, which is in the target blockchain information, of at least one block, whether the data change information in the block addition message is legitimate, and if legitimate, confirming the data change information in the block addition message.

2. The data processing method according to claim 1, further comprising:
receiving a notification message, which comprises the data change information, is with respect to an illegitimate operation and sent by any one node in the blockchain network; and
sanctioning an owner user who performs the illegitimate operation, if the illegitimate operation on the data change information is determined to belong to one of preset operations with serious circumstances.

3. The data processing method according to claim 1, further comprising:
when or after the data change information in the block addition message is determined to be illegitimate, if an operation on the data change information is determined to belong to one of preset operations with serious circumstances, adding an illegitimate authority declaration block into target blockchain information corresponding to all virtual data carriers of which the owner user is a target user who executes the operation, and broadcasting, so that other nodes in the blockchain network refuse to verify an ownership transfer block added by the target user onto the virtual data carrier onto which the illegitimate authority declaration block is added.

4. The data processing method according to claim 1, further comprising:
receiving an ownership transfer instruction which is with respect to the target virtual data carrier and sent by a corresponding owner user, the ownership transfer instruction comprising the digital identifier of the target virtual data carrier and a designated user identifier;
acquiring, according to the digital identifier of the target virtual data carrier, a current owner user identifier from a block involved in a last completed ownership transfer in a blockchain corresponding to the target virtual data carrier; and
judging whether the owner user identifier acquired from the block involved in the last completed ownership transfer is identical to an owner user identifier corresponding to the owner user who sends out the ownership transfer instruction; if identical, adding, based on the designated user identifier, a payment block to the blockchain corresponding to the target virtual data carrier, and broadcasting a block addition message corresponding to the payment block to the blockchain network,
wherein the data change information in the block addition message comprises change contents and the designated user identifier.

5. The data processing method according to claim 4, wherein, after broadcasting the block addition message corresponding to the payment block to the blockchain network, the method further comprises:
if a transfer confirmation message sent by a designated user of a transfer-out block corresponding to the block addition message is not received within a preset time period, adding a transfer cancellation block corresponding to the transfer-out block to the blockchain corresponding to the target virtual data carrier, and broadcasting a block addition message corresponding to the transfer cancellation block to the blockchain network,
wherein the transfer cancellation block is added by an original owner user who has added the corresponding transfer-out block.

6. The data processing method according to claim 4, wherein, after broadcasting the block addition message corresponding to the payment block to the blockchain network, the method further comprises:
if a transfer rejection message broadcast in the blockchain network by the designated user of the transfer-out block corresponding to the block addition message is received within a preset time period, determining that the current owner user of the corresponding target virtual data carrier is still the owner user who sends out the ownership transfer instruction with respect to the target virtual data carrier.

7. The data processing method according to claim 1, further comprising:
receiving a block addition message which corresponds to a transfer-out block with respect to the target virtual data carrier and is broadcast by any one node in the blockchain network; and
if the block addition message corresponding to the transfer-out block comprises an execution condition, after the execution condition is met, adding a reception block to a blockchain corresponding to the target virtual data carrier and broadcasting the reception block to the blockchain network, wherein the reception block comprises data that can prove that the execution condition has been met.

8. The data processing method according to claim 1, further comprising:
receiving a block addition message which corresponds to a transfer-out block with respect to the target virtual data carrier and is broadcast by any one node in the blockchain network; and
if a block addition message, which conflicts with the transfer-out block and sent out by any one node in the blockchain network, is received, and the designated user identifier in the transfer-out block is an identifier of a user on the node, adding a rejection block corresponding to the transfer-out block onto the blockchain corresponding to the target virtual data carrier, and broadcasting a block addition message corresponding to the rejection block to the blockchain network.

9. The data processing method according to claim 1, further comprising:
receiving a block addition message which corresponds to a transfer-out block with respect to the target virtual data carrier and is broadcast by any one node in the blockchain network;
judging whether the block addition message corresponding to the transfer-out block comprises association information, and if so, determining, according to the association information, features of all association initiation blocks in a corresponding associating operation; and
in a case of receiving all the association initiation blocks of the associating operation, adding association completion blocks to ends of the blockchains corresponding to the virtual data carrier that a user of the node itself needs to receive, and broadcasting the association completion blocks.

10. The data processing method according to claim 1, further comprising:
receiving a block addition message which corresponds to a payment block with respect to the target virtual data carrier and is broadcast by any one node in the blockchain network; and
judging whether an amount of owner users is more than one in the target virtual data carrier; and if so, determining, according to ownership contents of owner users corresponding to the respective owner user identifiers, whether the block addition message corresponding to the payment block is legitimate.

11. The data processing method according to claim 1, further comprising:
adding a mortgage block into the blockchain of the target virtual data carrier;
receiving a payment instruction sent by an owner user;
adding, according to the payment instruction, a payment block into a blockchain of other target virtual data carrier, and adding a progression block behind the mortgage block, wherein a serial number of the progression block is within a range set by the mortgage block, and does not overlap with a serial number of other progression block added behind the mortgage block, and the payment block comprises a digital identifier of a target virtual data carrier to which the mortgage block belongs and comprises a serial number of a corresponding progression block; and
broadcasting a block addition message corresponding to both the payment block and the progression block with respect to the target virtual data carrier in the blockchain network, so that other nodes in the blockchain network verify validity of the payment block and the progression block.

12. The data processing method according to claim 11, further comprising:
if the serial number of the progression block exceeds the range of a preset serial number of an original mortgage block, replacing or re-creating a new mortgage block on another target virtual data carrier, and adding the progression block behind the new mortgage block; and
broadcasting unowned-state information with respect to a virtual data carrier to which the original mortgage block belongs in the blockchain network, so that other users in the blockchain network compete for acquiring ownership of the virtual data carrier, to which the original mortgage block belongs, based on a preset rule.

13. The data processing method according to claim 1, further comprising:
acquiring respective data character information, wherein the data character information comprises any one item selected from the group consisting of an arbitrary face value of virtual currency, an arbitrary face value of legitimate currency, information of property of an arbitrary amount and content, information of raw material of an arbitrary content and quantity, information of an arbitrary person, and a transaction of an arbitrary content; and
creating, according to the respective data character information, respective virtual data carriers in one-to-one correspondence with the respective data character information and blockchains corresponding to the respective virtual data carriers, wherein root blocks of the respective blockchains, or virtual data carriers, to which the respective blockchains belong, both store inherent information of a corresponding virtual data carrier; the inherent information comprises the data character information; and a digital identifier of the corresponding virtual data carrier is calculated through the inherent information, so that the digital identifier can verify the corresponding inherent information.

14. The data processing method according to claim 13, wherein in a case where the data character information is a transaction, the data processing method further comprises:
creating a virtual data carrier storing a procedure or a rule of the transaction in inherent information, wherein all participants of the transaction execute the transaction according to the procedure or the rule; the procedure or the rule comprises adding, by a participant, a change block to a blockchain corresponding to the virtual data carrier in a mode prescribed by the procedure or the rule, to modify contents of the procedure or the rule.

15. The data processing method according to claim 13, wherein in a case where the data character information is the arbitrary face value of virtual currency or legitimate currency, the data processing method further comprises:
receiving an instruction, which is sent by an owner user, of creating a secondary virtual data carrier;
freezing one or more of the virtual data carriers whose current owner user is the owner user; and
creating at least one secondary virtual data carrier storing a designated face value, a total face value of the at least one secondary virtual data carrier being less than or equal to a total face value of the virtual data carriers.

16. The data processing method according to claim 13, wherein in a case where the data character information is information of raw materials or components of the arbitrary content and quantity, the data processing method further comprises:
freezing at least one virtual data carrier whose data character information is the information of raw materials or components of the arbitrary content and quantity; and
creating at least one secondary virtual data carrier storing a designated product, a sum of required raw materials or components required for a product of the secondary virtual data carrier being less than or equal to a sum of raw materials or components indicated by the data character information of the virtual data carrier.

17. The data processing method according to claim 1, further comprising:
receiving mortgage information of a virtual data carrier mortgaged by other participants; and
creating a fast channel between a participant on a current node and other participants who send out the mortgage information, wherein the fast channel is a virtual data carrier whose data character information is a transaction, inherent information or the blockchain of the virtual data carrier comprises a plurality of participants, a settlement condition, and virtual data carriers mortgaged by the respective participants, so that any one participant adds a corresponding delivery block to an end of a blockchain of the fast channel when the participant plans to perform delivery with other participants.

18. A node, comprising:
a block addition message receiving module, configure to receive a block addition message which is with respect to a target virtual data carrier and sent by any one node in a blockchain network, the block addition message comprising a digital identifier corresponding to the target virtual data carrier, and data change information, wherein the blockchain network comprises a plurality of virtual data carriers storing data character information, and each virtual data carrier is provided with a unique corresponding digital identifier and corresponds to at least one blockchain;
a target blockchain information acquiring module, configured to acquire target blockchain information corresponding to the target virtual data carrier, according to the digital identifier corresponding to the target virtual data carrier; and
a legitimacy judging module, configured to judge, based on data change history information, which is in the target blockchain information, of at least one block, whether the data change information in the block addition message is legitimate, and if legitimate, confirm the data change information in the block addition message.

19. A blockchain network, comprising a plurality of nodes, each of the plurality of nodes according to claim 18.

20. A virtual data carrier, wherein the virtual data carrier is configured to store data character information and provided with a unique digital identifier, each virtual data carrier corresponds to at least one blockchain; and
respective blockchains all belong to the blockchain network according to claim 19.

21. (canceled)

22. (canceled)
